(19) United States
(12) Patent Application Publication
(10) Pub. No.: US 2024/0413960 A1
(43) Pub. Date: Dec. 12, 2024

(54) METHOD AND DEVICE IN NODES USED FOR WIRELESS COMMUNICATION

(71) Applicants: Qi JIANG, Shanghai (CN); Ping WANG, Shanghai (CN); Xiaobo ZHANG, Shanghai (CN)

(72) Inventors: Qi JIANG, Shanghai (CN); Ping WANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/676,522

(22) Filed: May 29, 2024

(30) Foreign Application Priority Data
Jun. 8, 2023 (CN) 202310676024.8

(51) Int. Cl. H04L 5/14; H04L 5/00

(52) U.S. Cl. CPC H04L 5/14; H04L 5/0092

(57) ABSTRACT

A first node receives a target signaling, the target signaling indicating at least one symbol of first type, the at least one symbol of the first type including a downlink symbol for uplink transmission in a first sub-band that is indicated by TDD UL-DL configuration; and transmits a first signal; the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer, a distribution of the symbols of the first type in the target symbol set is used to determine the first integer. This application improves the uplink frequency hopping transmission procedure, and improves the anti-interference ability of signals.

### CROSS REFERENCE TO RELATED APPLICATIONS

This application claims the priority benefit of Chinese Patent Application No. 202310676024.8, filed on June 8,2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

In existing NR systems, spectrum resources are statically divided into Frequency Division Duplexing (FDD) spectrum and Time Division Duplexing (TDD) spectrum. For TDD spectrum, both the base station and UE (i.e., User Equipment) operate in half-duplex mode. This half-duplex mode avoids self-interference and mitigates the effects of Cross Link Interference (CLI), but it also brings problems such as reduced resource utilization and increased latency. In view of these problems, to support flexible duplex mode or variable link directions (Uplink, or Downlink, or Flexible ones) on the TDD spectrum or the FDD spectrum becomes a potential solution. In the 3GPP RAN #88e meeting and the 3GPP Rel-18 (also referred to as Release-18 or version 18) workshop, the support of more flexible duplex mode or full duplex mode in NR Rel-18 has been widely noticed and discussed, especially the Subband non-overlapping Full Duplex (SBFD) mode at the gNB (NR node B) end. Communication in this mode is subject to severe interference, including self-interference and CLI. To solve the interference problem, advanced interference cancellation techniques are required, including antenna isolation, beamforming, RF (Radio Frequency) level interference cancellation and digital interference cancellation.

### SUMMARY

In the existing standards, due to the PUSCH (i.e., Physical Uplink Shared CHannel) frequency-domain resource allocation type 1 and partial formats of PUCCH (i.e., Physical Uplink Control CHannel), the allocation in the frequency domain is done for continuous Resource Blocks (RBs), which needs to be discretized by frequency hopping to improve the anti-interference capability, reduce the probability of interception, and offer anti-fading support, so as to improve the communication quality. In SBFD scenarios, a PUSCH or PUCCH transmission may occupy both SBFD resources and non-SBFD resources, the interference environment varies with different resources, and the parameter configuration of uplink transmission may also be different, if the type of resources occupied by the signal is not taken into account for uplink frequency hopping transmission, the second-hop signal may be mapped into a SBFD slot for configuring resources outside the subband for uplink transmission, thus leading to uplink and downlink conflicts or resulting in fragmentation of uplink resources. Therefore, the hopping frequencies of PUSCH and PUCCH also need to be enhanced.

To address the above problem, the present application provides a solution. It should be noted that although the original intent of this application is for SBFD scenarios, this application can also be applied to other non-SBFD scenarios; further, the adoption of a unified design scheme for different scenarios (e.g., other non-SBFD scenarios including, but not limited to, capacity augmentation systems, systems for near field communications, unlicensed spectrum communications, Internet of Things (IoT), Ultra Reliable Low Latency Communication (URLLC) networks, Vehicle-to-everything (V2X), etc.) also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Particularly, for interpretations of the terminology; nouns, functions and variables (unless otherwise specified) in the present application, refer to definitions given in TS38 series and TS37 series of 3GPP specifications. Refer to 3GPP TS38.211, TS38.212, TS38.213, TS38.214, TS38.215, TS38.300, TS38.304, TS38.305, TS38.321, TS38.331, TS37.355, and TS38.423, if necessary; for a better understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a target signaling, the target signaling indicating at least one symbol of first type, the at least one symbol of the first type including a downlink symbol for uplink transmission in a first sub-band that is indicated by TDD uplink-downlink (UL-DL) configuration; and
transmitting a first signal;
herein, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, a problem to be solved in the present application includes: how the first node transmits the first signal in an SBFD scenario.

In one embodiment, a problem to be solved in the present application includes: how to achieve discretization in frequency domain of uplink transmission of the first node in an SBFD scenario.

In one embodiment, a problem to be solved in the present application includes: in an SBFD scenario, how to determine a frequency-domain starting position of a second-hop signal for an uplink frequency-hopping transmission.

In one embodiment, a problem to be solved in the present application includes: in an SBFD scenario, how to determine a first integer, the first integer being used to determine that the frequency-domain location of the target RB is located in a resource available for uplink transmission.

In one embodiment, characteristics of the above method include: the present application solves the above problem by associating the frequency-domain starting position of the second-hop signal of an uplink frequency-hopping transmission with the distribution of SBFD resources occupied by the first signal.

In one embodiment, characteristics of the above method include: the first signal is a PUSCH or a PUCCH.

In one embodiment, characteristics of the above method include: the present application supports scenarios where an uplink transmission channel is mapped to both SBFD resources and non-SBFD resources in the time domain.

In one embodiment, characteristics of the above method include: the present application supports scenarios where an uplink transmission channel is mapped in the time domain to only SBFD resources or non-SBFD resources.

In one embodiment, an advantage of the above method includes: increasing uplink resources and reducing signal transmission interruptions.

In one embodiment, an advantage of the above method includes: avoiding uplink and downlink conflicts that leads to transmission failure, and improving channel capacity.

In one embodiment, an advantage of the above method includes: reducing interference under the premise of ensuring frequency selective gain, and improving the anti-interference capability of signals.

In one embodiment, an advantage of the above method includes: establishing a link between the frequency-hopping method and the distribution of symbols of the first type in the target symbol set, avoiding the use of additional signaling indications, to improve spectral efficiency and reduce signaling overhead.

According to one aspect of the present application, the above method is characterized in that the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

In one embodiment, characteristics of the above method include: when the second-hop signal is mapped to an SBFD resource in the time domain, i.e., when the second-hop signal is mapped to be transmitted in a first sub-band of symbols of first type, the first integer is equal to a first candidate integer associated with the first sub-band, i.e., the signal after frequency hopping is located in the first sub-band to avoid interference and collisions.

In one embodiment, characteristics of the above method include: when the second-hop signal is mapped to a non-SBFD resource in the time domain, i.e., when the second-hop signal is mapped to be transmitted in an uplink BWP, the first integer is equal to a second candidate integer associated with the uplink BWP where the second-hop signal is located, i.e., the signal after frequency hopping is located in the uplink BWP to maximize frequency selective gain against fading.

In one embodiment, an advantage of the above method includes: avoiding the situation where the second-hop signal in an uplink frequency hopping transmission is mapped to a frequency-domain resource other than the frequency-domain resource occupied by the first sub-band that will result in a failure of the uplink transmission, particularly when the second-hop signal is occupying an SBFD resource.

In one embodiment, an advantage of the above method includes: avoiding fragmentation of uplink transmission resources.

In one embodiment, an advantage of the above method includes: maintaining consistency of signal transmissions and avoiding interruptions.

According to one aspect of the present application, the above method is characterized in that the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

In one embodiment, a problem to be solved in the present application includes: how to determine a first offset value in an SBFD scenario, the first offset value being used to determine an offset value of a frequency-domain starting position of the second sub-signal relative to a frequency-domain starting position of the first sub-signal.

In one embodiment, characteristics of the above method include: the present application solves the above problem by associating the first offset value with the distribution of SBFD resources occupied by the first signal.

In one embodiment, characteristics of the above method include: the second sub-signal uses different first offset values when it occupies different types of resources.

In one embodiment, an advantage of the above method includes: avoiding the situation where the second-hop signal in an uplink frequency hopping transmission is mapped to a frequency-domain resource other than the frequency-domain resource occupied by the first sub-band that will result in a failure of the uplink transmission, when the second-hop signal is occupying an SBFD resource.

In one embodiment, an advantage of the above method includes: maximizing frequency diversity gain to avoid uplink resource fragmentation when the second hop signal is occupying an SBFD resources.

In one embodiment, an advantage of the above method includes: maintaining consistency of signal transmissions and avoiding interruptions.

According to one aspect of the present application, the above method is characterized in that when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

In one embodiment, characteristics of the above method include: when the second-hop signal is mapped to an SBFD resource in the time domain, i.e., when the second-hop signal is mapped to be transmitted in a first sub-band of symbols of first type, the first offset value is equal to a first candidate offset value associated with the first sub-band.

In one embodiment, characteristics of the above method include: when a second-hop signal is mapped to a non-SBFD resource in the time domain, i.e., when the second-hop signal is mapped to be transmitted in an uplink BWP, the first offset value is equal to a second candidate offset value associated with the uplink BWP where the second-hop signal is located.

In one embodiment, an advantage of the above method includes: avoiding fragmentation of uplink transmission resources.

In one embodiment, an advantage of the above method includes: maintaining consistency of signal transmissions and avoiding interruptions.

In one embodiment, an advantage of the above method includes: rationally selecting the first offset value used for the first signal according to the bandwidth to enhance transmission performance.

According to one aspect of the present application, the above method is characterized in that the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

In one embodiment, a problem to be solved in the present application includes: in an SBFD scenario, how to determine a time-domain location for frequency hopping of the first signal in uplink FH transmission.

In one embodiment, characteristics of the above method include: the present application determines a time-domain location for frequency hopping of the first signal based on a distribution of types of resources among time-domain resources occupied by the first signal.

In one embodiment, characteristics of the above method include: the present application determines a time-domain location for frequency hopping of the first signal based on a distribution of SBFD resources among time-domain resources occupied by the first signal.

In one embodiment, an advantage of the above method includes: improving the reliability of uplink transmission and reducing interruptions of signal transmission.

In one embodiment, an advantage of the above method includes: improving the signal's anti-interference capability based on guaranteed frequency diversity gain.

In one embodiment, an advantage of the above method includes: avoiding fragmentation of the resources occupied by transmission and improving the transmission performance and efficiency.

According to one aspect of the present application, the above method is characterized in comprising:
receiving a first signaling;
herein, the first signaling is used to indicate the target symbol set, and the first signaling is used to indicate a starting RB occupied by the first sub-signal.

In one embodiment, characteristics of the above method comprise: the first signaling being used to schedule the first signal.

In one embodiment, characteristics of the above method comprise: the first signaling carrying configuration information for the first signal.

In one embodiment, characteristics of the above method comprise: the first signaling being used to activate the first signal.

In one embodiment, characteristics of the above method comprise: the first signaling being used to trigger a Channel State Information-Reference Signal (CSI-RS) transmission, the first signal carrying a CSI report.

In one embodiment, characteristics of the above method comprise: this application applies to uplink transmissions of dynamic grant and uplink transmissions of configured grant.

In one embodiment, an advantage of the above method includes: requiring only small changes to the current standard and having good backward compatibility.

According to one aspect of the present application, the above method is characterized in that a first field included in the first signaling is used to indicate the first offset value, and whether a padding bit is present in the first field included in the first signaling depends on the distribution of the symbols of the first type in the target symbol set.

In one embodiment, a problem to be solved in the present application comprises: how to indicate the first offset value in an SBFD scenario.

In one embodiment, an advantage of the above method includes: improving the reliability of the first field and the corresponding first signaling.

In one embodiment, an advantage of the above method includes: requiring only small changes to the current standard and having good backward compatibility.

According to one aspect of the present application, the above method is characterized in that the first node is a UE.

According to one aspect of the present application, the above method is characterized in that the first node is a relay node.

The present application provides a method in a second node for wireless communications, comprising:
transmitting a target signaling, the target signaling indicating at least one symbol of first type, the at least one symbol of the first type including a downlink symbol for uplink transmission in a first sub-band that is indicated by TDD uplink-downlink (UL-DL) configuration; and
receiving a first signal;
herein, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

According to one aspect of the present application, the above method is characterized in that the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

According to one aspect of the present application, the above method is characterized in that the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

According to one aspect of the present application, the above method is characterized in that when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

According to one aspect of the present application, the above method is characterized in that the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

According to one aspect of the present application, the above method is characterized in comprising:
transmitting a first signaling;
herein, the first signaling is used to indicate the target symbol set, and the first signaling is used to indicate a starting RB occupied by the first sub-signal.

According to one aspect of the present application, the above method is characterized in that a first field included in the first signaling is used to indicate the first offset value, and whether a padding bit is present in the first field included in the first signaling depends on the distribution of the symbols of the first type in the target symbol set.

According to one aspect of the present application, the above method is characterized in that the second node is a base station.

According to one aspect of the present application, the above method is characterized in that the second node is a UE.

According to one aspect of the present application, the above method is characterized in that the second node is a relay node.

The present application provides a first node for wireless communications, comprising:
a first receiver, receiving a target signaling, the target signaling indicating at least one symbol of first type, the at least one symbol of the first type including a downlink symbol for uplink transmission in a first sub-band that is indicated by TDD uplink-downlink (UL-DL) configuration; and
a first transmitter, transmitting a first signal;
herein, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

The present application provides a second node for wireless communications, comprising:
a second transmitter, transmitting a target signaling, the target signaling indicating at least one symbol of first type, the at least one symbol of the first type including a downlink symbol for uplink transmission in a first sub-band that is indicated by TDD uplink-downlink (UL-DL) configuration; and
a second receiver, receiving a first signal;
herein, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, compared with the prior art, the present application is advantageous in, but not limited to, the following aspects:
maintaining signal transmission consistency, reducing signal transmission interruptions, and improving the reliability of uplink transmission;
avoiding uplink and downlink transmission conflicts that leads to uplink transmission failure and improving channel capacity;
reducing interference and improving performance under the premise of ensuring frequency selective gains;
with small changes to current standards, and with good backward compatibility.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a schematic diagram of symbols of first type according to one embodiment of the present application.

FIG. 7 illustrates a schematic diagram of a distribution of symbols of the first type in a target symbol set according to one embodiment of the present application.

FIG. 8 illustrates a schematic diagram of the relationship between a first integer and a distribution of symbols of the first type in a target symbol set according to one embodiment of the present application.

FIG. 9 illustrates a schematic diagram of the relationship between a target RB and a first offset value according to one embodiment of the present application.

FIG. 10 illustrates a schematic diagram of the relationship between a first offset value and a distribution of symbols of the first type in a target symbol set according to one embodiment of the present application.

FIG. 11 illustrates a schematic diagram of a first symbol subset and a second symbol subset according to one embodiment of the present application.

FIG. 12 illustrates a schematic diagram of a first field of a first signaling according to one embodiment of the present application.

FIG. 13 illustrates a structure block diagram of a processing device used in a first node according to one embodiment of the present application.

FIG. 14 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

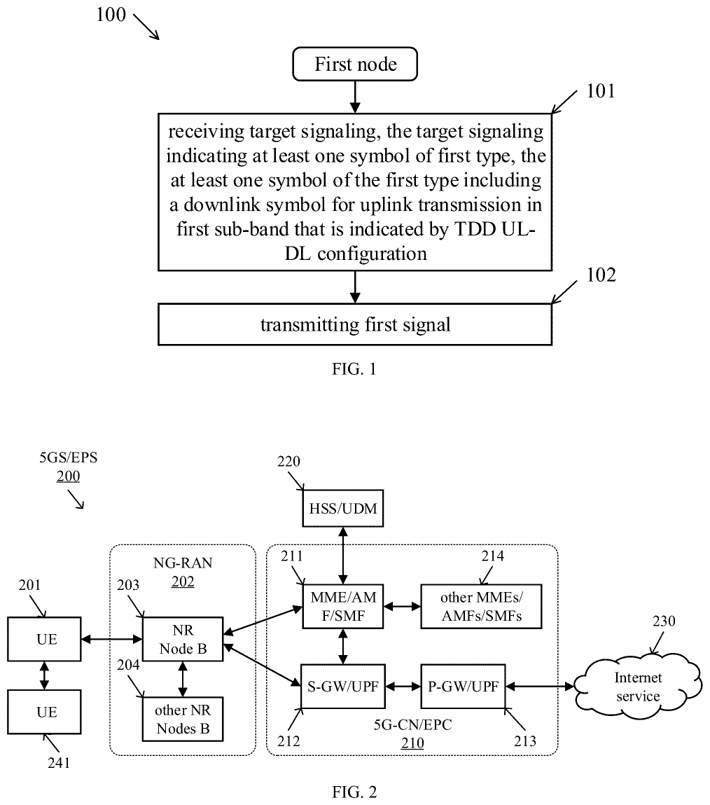

Embodiment 1 illustrates a flowchart of transmission of a first node according to one embodiment of the present application, as shown in FIG. 1. In FIG. 1, each box represents a step. Particularly, the sequential step arrangement in each box herein does not imply a chronological order of steps marked respectively by these boxes.

The first node receives a target signaling in step 101, the target signaling indicating at least one symbol of first type, the at least one symbol of the first type including a downlink symbol for uplink transmission in a first sub-band that is indicated by TDD uplink-downlink (UL-DL) configuration; and transmits a first signal in step 102.

In Embodiment 1, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the TDD refers to Time Division Duplex.

In one embodiment, the TDD refers to Time Division Duplexing.

In one embodiment, the BWP refers to BandWidth Part.

In one embodiment, the RB refers to Resource Block.

In one embodiment, the RB refers to Physical Resource Block (PRB).

In one embodiment, the RB refers to Virtual Resource Block (VRB).

In one embodiment, the RB refers to Common Resource Block (CRB).

Typically, an RB occupies 12 consecutive subcarriers in frequency domain.

In one embodiment, the target signaling comprises a higher layer signaling.

In one embodiment, the target signaling comprises a Radio Resource Control (RRC) signaling.

In one embodiment, the target signaling comprises a plurality of RRC messages.

In one embodiment, the target signaling is an RRC message.

In one embodiment, the target signaling comprises one or more RRC Information Elements (IEs).

In one embodiment, the target signaling comprises a plurality of RRC IEs.

In one embodiment, the target signaling is an RRC IE.

In one embodiment, the target signaling comprises one or more fields in an RRC IE.

In one embodiment, the target signaling is used to indicate a symbol type.

In one embodiment, the target signaling is used to indicate a symbol period, the symbol period including a period of a symbol type.

In one embodiment, the symbol type includes the first type of symbols.

In one embodiment, the symbol type includes at least one of UpLink (UL) symbol, DownLink (DL) symbol or flexible symbol.

In one embodiment, the symbol type includes at least one type of symbol other than UL symbol, DL symbol and flexible symbol.

In one embodiment, the symbol type includes at least one of the first type of symbol, UL symbol, DL symbol or flexible symbol.

In one embodiment, the target signaling is used by the second node of the present application to indicate at least 1 symbol of first type.

In one embodiment, all or part of the target signaling is used to explicitly or implicitly indicate at least 1 symbol of first type.

In one embodiment, the target signaling is used to indicate at least 1 symbol and the target signaling is used to indicate that at least 1 symbol is of the first type.

In one embodiment, the target signaling is used to indicate that at least 1 symbol is a symbol of the first type.

In one embodiment, the target signaling is used to indicate at least 1 symbol of the first type based on a reference subcarrier spacing.

In one embodiment, the target signaling is used to indicate at least 1 symbol of the first type within a period.

In one embodiment, the target signaling is further used to indicate a reference subcarrier spacing, the target signaling indicating at least 1 symbol of the first type based on the reference subcarrier spacing.

In one embodiment, the target signaling is cell-common signaling.

In one embodiment, the target signaling comprises a TDD-UL-DL-ConfigCommon IE.

In one embodiment, the target signaling is UE-dedicated signaling.

In one embodiment, the target signaling comprises a TDD-UL-DL-ConfigDedicated IE.

In one embodiment, the target signaling comprises at least a former of a TDD-UL-DL-ConfigCommon IE and a TDD-UL-DL-ConfigDedicated IE.

In one embodiment, the target signaling comprises a TDD-UL-DL-Pattern field.

In one embodiment, a name of an RRC signaling carrying the target signaling includes “TDD”.

In one embodiment, a name of an RRC signaling carrying the target signaling includes “DL”.

In one embodiment, a name of an RRC signaling carrying the target signaling includes “UL”.

In one embodiment, a name of an RRC signaling carrying the target signaling includes “Config”.

In one embodiment, a name of an RRC signaling carrying the target signaling includes “SBFD”.

In one embodiment, a name of an RRC signaling carrying the target signaling includes “subband”.

In one embodiment, a name of an RRC signaling carrying the target signaling includes “duplex”.

In one embodiment, the target signaling comprises a Medium Access Control (MAC) Control Element (CE).

In one embodiment, the target signaling comprises a dynamic signaling.

In one embodiment, the target signaling comprises a physical-layer signaling.

In one embodiment, the target signaling comprises a Layer 1 (L1) signaling.

In one embodiment, the target signaling comprises Downlink Control Information (DCI).

In one embodiment, the target signaling comprises part of or all fields in a DCI.

In one embodiment, the target signaling is a DCI.

In one embodiment, the target signaling comprises a DCI, with Cyclic Redundancy Check (CRC) of the DCI being scrambled by a Slot Format Indication (SFI)-Radio Network Temporary Identifier (RNTI).

In one embodiment, the target signaling comprises a DCI, with a format of the DCI being DCI format 2_0.

In one embodiment, the target signaling comprises a SFI.

In one embodiment, the target signaling is a SFI.

In one embodiment, the target signaling is carried by both the RRC layer and the physical layer.

In one embodiment, the target signaling comprises an RRC signaling and part of or all fields of a DCI.

In one subembodiment, the RRC signaling comprises at least a former of a TDD-UL-DL-ConfigCommon IE and a TDD-UL-DL-ConfigDedicated IE.

In one subembodiment, the format of the DCI is DCI format 2_0.

In one embodiment, the TDD uplink-downlink (UL-DL) configuration is indicated via higher layer signaling.

In one embodiment, the TDD uplink-downlink (UL-DL) configuration is indicated via semi-static signaling.

In one embodiment, the TDD uplink-downlink (UL-DL) configuration is indicated via RRC signaling.

In one embodiment, the TDD uplink-downlink (UL-DL) configuration is indicated via cell-common signaling.

In one embodiment, the TDD uplink-downlink (UL-DL) configuration is indicated via UE group-common signaling.

In one embodiment, the TDD uplink-downlink (UL-DL) configuration is indicated via a TDD-UL-DL-ConfigCommon IE.

In one embodiment, the TDD uplink-downlink (UL-DL) configuration is indicated via UE dedicated/specific signaling.

In one embodiment, the TDD uplink-downlink (UL-DL) configuration is indicated via a TDD-UL-DL-ConfigDedicated IE.

In one embodiment, the TDD uplink-downlink (UL-DL) configuration is indicated via both a TDD-UL-DL-ConfigCommon IE and a TDD-UL-DL-ConfigDedicated IE.

In one embodiment, the TDD uplink-downlink (UL-DL) configuration is indicated via a TDD-UL-DL-Pattern field.

In one embodiment, the TDD uplink-downlink (UL-DL) configuration is used to indicate downlink slots and downlink symbols during a period.

In one embodiment, the TDD uplink-downlink (UL-DL) configuration is used to indicate that at least 1 slot during a period is a downlink slot and/or that at least one symbol is a downlink symbol.

In one embodiment, the TDD uplink-downlink (UL-DL) configuration is used to indicate at least 1 slot format, the at least 1 slot format being used to determine at least 1 downlink symbol.

In one embodiment, the TDD uplink-downlink (UL-DL) configuration is used to indicate from a period at least 1 slot comprising only downlink symbols and at least 1 downlink symbol following the slot(s) comprising only downlink symbols.

In one embodiment, the TDD uplink-downlink (UL-DL) configurations are used to indicate a number of starting downlink slot(s) and a number of downlink symbols immediately following the starting downlink slot(s) within one period, and a length of the period.

In one embodiment, the TDD uplink-downlink (UL-DL) configuration is used to indicate at least 1 pattern, and any one pattern indicated by the TDD uplink-downlink (UL-DL) configuration provides a slot configuration period length, a number of slots comprising only downlink symbols, a number of downlink symbols, a number of slots comprising only uplink symbols and a number of uplink symbols.

In one embodiment, the TDD uplink-downlink (UL-DL) configuration is used to indicate at least 1 pattern, the at least 1 pattern indicated by the TDD uplink-downlink (UL-DL) configuration providing at least 1 slot comprising only downlink symbols and at least 1 downlink symbol that is not part of the slot(s) comprising only downlink symbols in a period.

In one embodiment, the TDD uplink-downlink (UL-DL) configuration is indicated via MAC layer signaling.

In one embodiment, the TDD uplink-downlink (UL-DL) configuration is indicated via MAC CE.

In one embodiment, a name of a signaling carrying the TDD uplink-downlink (UL-DL) configuration includes “TDD”.

In one embodiment, a name of a signaling carrying the TDD uplink-downlink (UL-DL) configuration includes “DL”.

In one embodiment, a name of a signaling carrying the TDD uplink-downlink (UL-DL) configuration includes “UL”.

In one embodiment, a name of a signaling carrying the TDD uplink-downlink (UL-DL) configuration includes “Config”.

In one embodiment, a name of a signaling carrying the TDD uplink-downlink (UL-DL) configuration includes “SBFD”.

In one embodiment, a name of a signaling carrying the TDD uplink-downlink (UL-DL) configuration includes “subband”.

In one embodiment, a name of a signaling carrying the TDD uplink-downlink (UL-DL) configuration includes “duplex”.

In one embodiment, the TDD uplink-downlink (UL-DL) configuration is indicated via dynamic signaling.

In one embodiment, the TDD uplink-downlink (UL-DL) configuration is indicated via physical layer signaling.

In one embodiment, the TDD uplink-downlink (UL-DL) configuration is indicated via L1 signaling.

In one embodiment, the TDD uplink-downlink (UL-DL) configuration is indicated via a DCI.

In one embodiment, the TDD uplink-downlink (UL-DL) configuration is indicated via dynamic scheduling signaling, the dynamic scheduling signaling comprising part of or all fields of a DCI.

In one subembodiment, the word indicate refers to implicit indicating.

In one subembodiment, a CRC of the DCI is scrambled by a UE-specific RNTI.

In one subembodiment, a CRC of the DCI is scrambled by a Cell-RNTI (C-RNTI).

In one subembodiment, a CRC of the DCI is scrambled by a Modulation and Coding Scheme (MCS)-C-RNTI.

In one subembodiment, a CRC of the DCI is scrambled by a Temporary Cell-RNTI (TC-RNTI).

In one subembodiment, the format used for the DCI is DCI format 0_0 or DCI format 1_0.

In one subembodiment, the format used for the DCI is one of DCI format 0_1, DCI format 0_2, DCI format 1_1 or DCI format 1_2.

In one embodiment, the benefits of the above method include: saving signaling overhead without requiring additional signaling to indicate a symbol type.

In one embodiment, the TDD uplink-downlink (UL-DL) configuration is indicated via dynamic non-scheduling signaling.

In one embodiment, the TDD uplink-downlink (UL-DL) configuration is indicated via dynamic non-scheduling signaling, the dynamic non-scheduling signaling comprising part of or all fields of a DCI.

In one subembodiment, the word indicate refers to explicit indicating.

In one subembodiment, a CRC of the DCI is scrambled by a Cell-common RNTI.

In one subembodiment, a CRC of the DCI is scrambled by a UE group-common RNTI.

In one subembodiment, a CRC of the DCI is scrambled by an SFI-RNTI.

In one subembodiment, the DCI is SFI.

In one subembodiment, a format used for the DCI is DCI format 2_0.

In one embodiment, the benefits of the above method include: suitability for both signal transmissions of dynamic grant and configured grant.

In one embodiment, the TDD uplink-downlink (UL-DL) configuration is indicated via RRC layer signaling and physical layer signaling together.

In one embodiment, the TDD uplink-downlink (UL-DL) configuration is carried by RRC layer signaling and physical layer signaling together.

In one subembodiment, the RRC signaling comprises at least a former of a TDD-UL-DL-ConfigCommon IE and a TDD-UL-DL-ConfigDedicated IE.

In one subembodiment, the physical layer signaling comprises part of or all fields of a DCI.

In one subembodiment, the physical layer signaling is SFI.

In one embodiment, the benefits of the above method include: providing more flexibility by allowing dynamic signaling's adaptive indication of semi-statically configured symbol resources.

In one embodiment, the target signaling and the TDD uplink-downlink (UL-DL) configuration both include RRC signaling, and the target signaling and the TDD uplink-downlink (UL-DL) configuration belong to a same RRC IE.

In one embodiment, the TDD uplink-downlink (UL-DL) configuration is indicated by the target signaling.

In one embodiment, the TDD uplink-downlink (UL-DL) configuration is carried by the target signaling.

In one embodiment, the target signaling includes the TDD uplink-downlink (UL-DL) configuration.

In one embodiment, the target signaling is the TDD uplink-downlink (UL-DL) configuration.

In one embodiment, the first sub-band occupies at least one RB set in frequency domain.

In one subembodiment, the one RB set is a set of consecutive RBs.

In one subembodiment, the RB set is configured by a higher layer parameter “IntraCellGuardBandsPerSCS”.

In one subembodiment, the RB set is configured by a higher layer parameter “intraCellGuardBandsUL-List”.

In one subembodiment, a guard band exists between two neighboring RB sets.

In one embodiment, there exist guard bands at both ends of the first sub-band in frequency domain.

In one embodiment, there exists a guard band at one end of the first sub-band in frequency domain.

In one embodiment, there exist no guard bands at both ends of the first sub-band in frequency domain.

In one subembodiment of the above three embodiments, the guard band is not used for uplink transmission or downlink transmission.

In one embodiment, the first sub-band comprises a guard band.

In one embodiment, the first sub-band comprises no guard band.

In one embodiment, the first sub-band occupies at least one RB in frequency domain.

In one subembodiment, the at least one RB includes one RB.

In one subembodiment, the at least one RB includes a plurality of consecutive RBs.

In one embodiment, the first sub-band occupies a plurality of subcarriers in frequency domain.

In one embodiment, the first sub-band occupies a plurality of consecutive subcarriers in frequency domain.

In one embodiment, the first sub-band belongs to a UL carrier.

In one embodiment, frequency-domain resources occupied by the first sub-band belong to one UL carrier.

In one embodiment, the UL carrier in this application comprises a Normal Uplink (NUL) carrier.

In one embodiment, the UL carrier in the present application comprises a Supplementary UL (SUL) carrier.

In one embodiment, the first sub-band belongs to a DL carrier.

In one embodiment, frequency-domain resources occupied by the first sub-band belong to a DL carrier.

In one embodiment, the first sub-band belongs to a BWP.

In one embodiment, the first sub-band belongs to a UL BWP.

In one embodiment, frequency-domain resources occupied by the first sub-band belong to a UL BWP.

In one embodiment, the first sub-band belongs to a DL BWP.

In one embodiment, frequency-domain resources occupied by the first sub-band belong to a DL BWP.

In one embodiment, there is overlapping frequency-domain resource between the first sub-band and a UL BWP.

In one embodiment, there is no overlapping frequency-domain resource between the first sub-band and a UL BWP.

In one embodiment, the first sub-band comprises a SubBand non-overlapping Full Duplex (SBFD) subband.

In one embodiment, the first sub-band is an SBFD subband.

In one embodiment, the frequency-domain resources occupied by the first sub-band comprise frequency-domain resources occupied by one SBFD subband.

In one embodiment, the frequency-domain resources occupied by the first sub-band are overlapped with frequency-domain resources occupied by one SBFD subband.

In one embodiment, the frequency-domain resources occupied by the first sub-band comprise some or all of frequency-domain resources occupied by one SBFD subband.

In one embodiment, the frequency-domain resources occupied by the first sub-band comprise frequency-domain resources other than the frequency-domain resources occupied by one SBFD subband.

In one embodiment, the one SBFD subband in this application is used for uplink transmission.

In one embodiment, the one SBFD subband in this application can be used for uplink transmission.

In one embodiment, the one SBFD subband in this application is a UL subband.

In one embodiment, the first sub-band is configured via RRC signaling.

In one embodiment, the first sub-band is configured via Cell-common RRC signaling.

In one embodiment, the first sub-band is configured via UE group-common RRC signaling.

In one embodiment, the first sub-band is configured via the target signaling in this application.

In one embodiment, the target signaling is used to determine that the first node may perform uplink transmissions in the first sub-band in the symbols of the first type.

In one embodiment, the target signaling is used to determine that the first node is capable of performing uplink transmissions in the first sub-band in the symbols of the first type.

In one embodiment, the target signaling is used to determine that the first node is allowed to perform uplink transmissions in the first sub-band in the symbols of the first type.

In one embodiment, the target signaling is used to determine that the first node may transmit signals in the first sub-band in the symbols of the first type.

In one embodiment, the target signaling is used to determine that the first node is capable of transmitting signals in the first sub-band in the symbols of the first type.

In one embodiment, the target signaling is used to determine that the first node is allowed to transmit signals in the first sub-band in the symbols of the first type.

In one embodiment, the benefits of the above method include: saving signaling overhead without requiring additional signaling to indicate a link direction of the first sub-band.

In one embodiment, the first signal comprises a baseband signal.

In one embodiment, the first signal comprises a radio frequency signal.

In one embodiment, the first signal comprises a radio signal.

In one embodiment, the first signal corresponds to an Uplink (UL) Grant.

In one embodiment, the first signal is a Physical Uplink Shared CHannel (PUSCH) transmission based on dynamic scheduling.

In one embodiment, the benefits of the above method include that it is suitable for uplink transmission of dynamic grant.

In one embodiment, the first signal is a PUSCH transmission based on a configured grant.

In one embodiment, the benefits of the above method include that it is suitable for uplink transmission of configured grant.

In one embodiment, the frequency-domain allocation type of the first signal is type 1.

In one embodiment, the first signal carries a bit block, the bit block comprising at least one Transport block (TB) or at least one Code Block Group (CBG).

In one embodiment, the first signal carries physical layer control information.

In one embodiment, the first signal carries a Channel State Information (CSI) report.

In one embodiment, the first signal comprises Uplink Control Information (UCI).

In one embodiment, a UCI payload employing a UCI format is used to generate the first signal.

In one embodiment, the first signal comprises a Hybrid Automatic Repeat reQuest ACKnowledgement (HARQ-ACK).

In one embodiment, a physical layer channel occupied by the first signal includes a Physical Uplink Control CHannel (PUCCH).

In one subembodiment, a PUCCH format corresponding to the first signal is PUCCH format 1.

In one subembodiment, a PUCCH format corresponding to the first signal is PUCCH format 3.

In one subembodiment, a PUCCH format corresponding to the first signal is PUCCH format 4.

In one embodiment, time-frequency resources occupied by the first signal are shared by a plurality of UEs.

In one embodiment, time-frequency resources occupied by the first signal are allocated only to the first node.

In one embodiment, the first sub-signal and the second sub-signal are respectively a first hop and a second hop of the first signal.

In one embodiment, the first sub-band comprises at least one of frequency-domain resources occupied by the first sub-signal or frequency-domain resources occupied by the second sub-signal.

In one embodiment, the first sub-band comprises frequency-domain resources occupied by the first sub-signal.

In one embodiment, the first sub-band comprises frequency-domain resources occupied by the second sub-signal.

In one embodiment, the first sub-band comprises both the frequency-domain resources occupied by the first sub-signal and the frequency-domain resources occupied by the second sub-signal.

In one embodiment, the first sub-band does not include the frequency-domain resources occupied by the first sub-signal and the first sub-band does not include the frequency-domain resources occupied by the second sub-signal.

In one embodiment, the target symbol set comprises a plurality of consecutive symbols.

In one embodiment, the target symbol set comprises K1 symbols, K1 being a positive integer greater than 1.

In one subembodiment, the K1 symbols are consecutive.

In one embodiment, the target symbol set comprises at least one symbol of the first type.

In one embodiment, the target symbol set comprises only the symbols of the first type.

In one embodiment, the target symbol set comprises at least one symbol other than the symbols of the first type.

In one embodiment, the target symbol set comprises only symbols other than the symbols of the first type.

In one embodiment, the target symbol set comprises at least one symbol of the first type and at least one symbol other than the symbol(s) of the first type.

In one embodiment, the target signaling is used to indicate the type of each symbol in the target symbol set.

In one embodiment, the target signaling is used to determine the type of each symbol in the target symbol set.

In one embodiment, the first signal occupies consecutive time-domain resources in time domain.

In one embodiment, the first signal occupies multiple consecutive symbols in time domain.

In one embodiment, the first signal occupies each symbol in the target symbol set.

In one embodiment, the first signal does not occupy any time-domain resources outside the target symbol set.

In one embodiment, the symbol in the present application is a single-carrier symbol.

In one embodiment, the symbol in the present application is a multi-carrier symbol.

In one embodiment, the multi-carrier symbol in the present application is a Single Carrier-Frequency Division Multiple Access (SC-FDMA) symbol.

In one embodiment, the multi-carrier symbol in the present application is a Filter Bank Multi Carrier (FBMC) symbol.

In one embodiment, the multi-carrier symbol in the present application is an Orthogonal Frequency Division Multiplexing (OFDM) Symbol.

In one embodiment, the symbol in the present application is obtained by an output by transform precoding through OFDM Symbol Generation.

In one embodiment, the multi-carrier symbol in the present application is a Discrete Fourier Transform-spread-OFDM (DFT-s-OFDM) symbol.

In one embodiment, the multi-carrier symbol in the present application includes Cyclic Prefix-OFDM (CP-OFDM) symbol.

In one embodiment, the first sub-signal occupies consecutive frequency-domain resources in frequency domain.

In one embodiment, the first sub-signal occupies consecutive RBs in frequency domain, the consecutive RBs having consecutive RB indexes.

In one embodiment, the second sub-signal occupies consecutive frequency-domain resources in frequency domain.

In one embodiment, the second sub-signal occupies consecutive RBs in frequency domain, the consecutive RBs having consecutive RB indexes.

In one embodiment, the target RB is an RB with the lowest center frequency among RBs occupied by the second sub-signal in frequency domain.

In one embodiment, the target RB is an RB with the smallest RB index among RBs occupied by the second sub-signal in frequency domain.

In one embodiment, the RB with the smallest RB index refers to: an RB that occupies frequency-domain resource at the lowest frequency.

In one embodiment, the RB with the smallest RB index refers to: an RB with the smallest PRB index.

In one embodiment, the RB with the smallest RB index refers to: an RB with the smallest VRB index.

In one embodiment, the RB with the smallest RB index refers to: an RB with the smallest CRB index.

In one embodiment, the PRB index means n_{PRB}^{μ}, where μ is a subcarrier spacing configuration.

In one embodiment, the n_{PRB}^{μ} is specifically defined in 3GPP (that is, the 3rd Generation Partnership Project) TS (i.e., Technical Specification) 38.211.

In one embodiment, PRBs in a BWP are numbered from 0 to N_{w}−1, where N_{w} is a number of PRBs included in the BWP.

In one embodiment, VRBs in a BWP are numbered from 0 to N_{w}−1, where N_{w} is a number of PRBs included in the BWP.

In one embodiment, the CRB index is n_{CRB}^{μ}, μ being a subcarrier spacing configuration.

In one embodiment, the n_{CRB}^{μ} is specifically defined in 3GPP TS 38.211.

In one embodiment, the CRB index increases sequentially from 0 upwards in the frequency domain.

In one embodiment, the PRB n_{PRB}^{μ} in the BWP i is mapped to CRB n_{CRB}^{μ}, and the relationship between the PRB n_{PRB}^{μ} in the BWP i and the CRB n_{CRB}^{μ} is: n_{CRB}^{μ}=n_{PRB}^{μ}+N_{BWP,i}^{start,μ}, where N_{BWP,i}^{start,μ} is the starting CRB of BWP i relative to CRB#0.

In one embodiment, the PRB to CRB mapping relationship is specified in Section 4.4.4.4 of 3GPP TS 38.211.

In one embodiment, the PRB to CRB mapping relationship is specified in Section 7.3.1.6 or 6.3.1.7 of 3GPP TS 38.211.

In one embodiment, the frequency-domain location of the target RB comprises an RB Index of the target RB.

In one embodiment, the frequency-domain location of the target RB comprises a frequency-domain location of the target RB in a UL carrier.

In one embodiment, the frequency-domain location of the target RB comprises a frequency-domain location of the target RB in a DL carrier.

In one embodiment, the frequency-domain location of the target RB comprises a frequency-domain location of the target RB in a UL BWP.

In one embodiment, the frequency-domain location of the target RB comprises a frequency-domain location of the target RB in a DL BWP.

In one embodiment, the frequency-domain location of the target RB comprises a frequency-domain location of the target RB in the first sub-band.

In one embodiment, the first integer is a positive integer greater than 1.

In one embodiment, the frequency-domain location of the target RB depends on the first integer.

In one embodiment, the first integer is used to determine the frequency-domain location of the target RB.

In one embodiment, the RB Index of the target RB is less than the first integer.

In one embodiment, the RB Index of the target RB is less than a sum of the first integer and a second index.

In one subembodiment, the second index is an RB index of a starting RB of a UL BWP associated with the first signal, the RB index of the starting RB of the UL BWP being on a common resource grid relative to CRB#0.

In one subembodiment, the second index is an RB index of a starting RB of the first sub-band associated with the first signal, the RB index of the starting RB of the first sub-band being on a common resource grid relative to CRB#0.

In one embodiment, a number of RBs included in the first sub-band is equal to the first candidate integer.

In one embodiment, a number of RBs occupied by the first sub-band is equal to the first candidate integer.

In one embodiment, the first candidate integer is a positive integer greater than 1.

In one embodiment, a number of RBs included in an uplink BWP associated with the first signal is equal to a second candidate integer.

In one embodiment, a number of RBs occupied by an uplink BWP associated with the first signal is equal to a second candidate integer.

In one embodiment, the second candidate integer is a positive integer greater than 1.

In one embodiment, the uplink BWP associated with the first signal comprises: an uplink BWP to which the frequency-domain resources occupied by the first signal belong.

In one embodiment, the uplink BWP associated with the first signal comprises: an uplink BWP to which the frequency-domain resources occupied by the first sub-signal belong.

In one embodiment, the uplink BWP associated with the first signal comprises: an uplink BWP to which the frequency-domain resources occupied by the second sub-signal belong.

In one embodiment, the uplink BWP associated with the first signal comprises: an uplink BWP to which an RRC parameter for configuring transmission of the first signal belongs.

In one embodiment, the uplink BWP associated with the first signal comprises: an uplink BWP in a BWP pair to which an RRC parameter for configuring transmission of the first signal belongs.

In one embodiment, the uplink BWP associated with the first signal comprises: an uplink BWP being associated with a downlink BWP to which the frequency-domain resources occupied by the first signal belong.

In one embodiment, the uplink BWP associated with the first signal comprises: an uplink BWP being associated with a downlink BWP to which the frequency-domain resources occupied by the first sub-signal belong.

In one embodiment, the uplink BWP associated with the first signal comprises: an uplink BWP being associated with a downlink BWP to which the frequency-domain resources occupied by the second sub-signal belong.

In one embodiment, the uplink BWP associated with the first signal comprises: an uplink BWP which is active at the time of transmitting the first signal.

In one embodiment, the uplink BWP associated with the first signal comprises: an uplink BWP being associated with a downlink BWP which is active at the time of transmitting the first signal.

In one embodiment, the uplink BWP associated with the first signal comprises: an uplink BWP indicated by a DCI that schedules the first signal.

In one embodiment, the first integer is the first candidate integer.

In one embodiment, the first integer is the second candidate integer.

In one embodiment, the feature of “distribution of the symbols of the first type in the target symbol set” means: whether the target symbol set includes the symbols of the first type.

In one subembodiment, the target symbol set includes only symbols other than the symbol(s) of the first type, and the first integer is equal to the second candidate integer; the target symbol set includes only the symbols of the first type, and the first integer is equal to the first candidate integer.

In one embodiment, an advantage of the above method includes: having good backward compatibility.

In one embodiment, the feature of “distribution of the symbols of the first type in the target symbol set” means: whether the symbols of the first type are in a front part or a rear part of the target symbol set.

In one embodiment, the feature of “distribution of the symbols of the first type in the target symbol set” means: the number the symbols of the first type in the target symbol set.

In one subembodiment, a number of the symbols of the first type in the target symbol set is not less than a first threshold, and the first integer is equal to the first candidate integer; or the number of the symbols of the first type in the target symbol set is less than the first threshold, and the first integer is equal to the second candidate integer; the first threshold is a positive integer greater than 1, the first threshold is fixed, or the first threshold is predefined, or the first threshold is configured by RRC signaling.

In one embodiment, the feature of “distribution of the symbols of the first type in the target symbol set” means: a proportion of the number of the symbols of the first type in the target symbol set to all symbols included in the target symbol set.

In one subembodiment, a proportion of a number of the symbols of the first type in the target symbol set to all symbols included in the target symbol set is no less than a second threshold, and the first integer is equal to the first candidate integer; or the proportion of the number of the symbols of the first type in the target symbol set to all symbols included in the target symbol set is less than a second threshold, and the first integer is equal to the second candidate integer; the second threshold is a real number greater than 0 and less than 1, the second threshold is fixed, or the second threshold is predefined, or the second threshold is configured by RRC signaling.

In one embodiment, the benefits of the above method include: providing more flexibility in determining the first integer, which facilitates rational allocation of uplink resources.

### Embodiment 2

Embodiment 2 illustrates a schematic diagram of a network architecture according to one embodiment of the present application, as shown in FIG. 2.

FIG. 2 illustrates a network architecture of Long-Term Evolution (LTE), Long-Term Evolution Advanced (LTE-A) and future 5G systems. The network architecture of the LTE, LTE-A and future 5G systems may be called an Evolved Packet System (EPS). The 5G NR or LTE network architecture may be referred to as 5G System (5GS)/EPS 200 or some other suitable terminology. The 5GS/EPS 200 may comprise one or more UEs 201, a UE 241 in sidelink communication with the UE(s) 201, an NG-RAN 202, a 5G Core Network/Evolved Packet Core (5G-CN/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane terminations. The gNB 203 can be connected to other gNBs 204 via an Xn interface (like backhaul). The gNB 203 may be called a base station, a base transceiver station, a radio base station, a radio transceiver, a transceiver function, a Basic Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 itself is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and packet switching (PS) services.

In one embodiment, the first node in the present application includes the UE 201.

In one embodiment, the second node in the present application includes the gNB203.

In one embodiment, the UE 201 includes cellphone.

In one embodiment, the UE 201 is a means of transportation including automobile.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB203 is a flight platform.

In one embodiment, the gNB203 is satellite equipment.

In one embodiment, the gNB 203 is a piece of test equipment (e.g., a transceiving device simulating partial functions of the base station, or a signaling test instrument).

In one embodiment, a radio link from the UE 201 to the gNB 203 is an uplink, the uplink being used for performing uplink transmission.

In one embodiment, a radio link from the gNB 203 to the UE 201 is a downlink, the downlink being used for performing downlink transmission.

In one embodiment, a radio link between the UE201 and the gNB203 includes a cellular link.

In one embodiment, the UE 201 and the gNB 203 are connected to each other via a Uu air interface.

In one embodiment, the transmitter of the target signaling includes the gNB 203.

In one embodiment, the receiver of the target signaling includes the UE 201.

In one embodiment, the transmitter of the first signal includes the UE 201.

In one embodiment, the receiver of the first signal includes the gNB 203.

In one embodiment, the UE 201 supports SBFD.

In one embodiment, the UE 201 supports a more flexible duplex mode or full duplex mode.

In one embodiment, the gNB 203 supports SBFD.

In one embodiment, the gNB 203 supports a more flexible duplex mode or full duplex mode.

### Embodiment 3

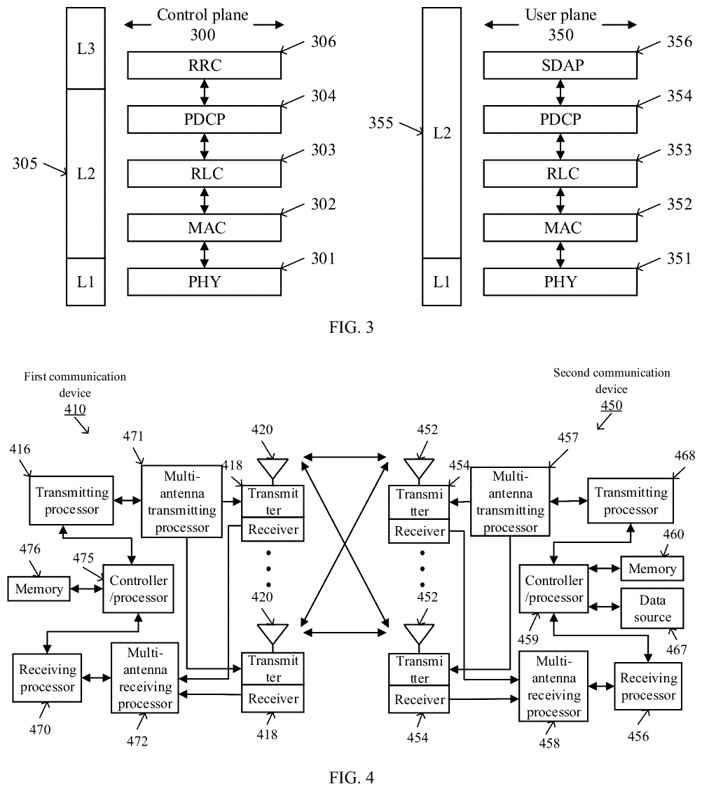

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything (V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., Layer 1 (L1), Layer 2 (L2) and Layer 3 (L3). The L1 is the lowest layer which performs various signal processing functions of PHY (i.e., PHYsical layer). The L1 is called PHY 301 in the present application. The L2 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., Internet Protocol/IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the target signaling is generated by the RRC 306.

In one embodiment, the target signaling is generated by the MAC sublayer 302 or the MAC sublayer 352.

In one embodiment, the target signaling is generated by the PHY 301 or the PHY 351.

In one embodiment, the first signal is generated by the PHY 301 or the PHY 351.

In one embodiment, the higher layer in the present application refers to a layer above the PHY layer.

In one embodiment, the higher layer in the present application comprises a MAC layer.

In one embodiment, the higher layer in the present application comprises an RRC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using ACKnowledgement (ACK) and/or Negative ACKnowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a target signaling, the target signaling indicating at least one symbol of first type, the at least one symbol of the first type including a downlink symbol for uplink transmission in a first sub-band that is indicated by TDD uplink-downlink (UL-DL) configuration; and transmits a first signal; the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the second communication device 450 comprises a memory that stores a computer readable instruction program. The computer readable instruction program generates actions when executed by at least one processor. The actions include: receiving a target signaling; and transmitting a first signal.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a target signaling, the target signaling indicating at least one symbol of first type, the at least one symbol of the first type including a downlink symbol for uplink transmission in a first sub-band that is indicated by TDD uplink-downlink (UL-DL) configuration; and receives a first signal; the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the first communication device 410 comprises a memory that stores a computer readable instruction program. The computer readable instruction program generates actions when executed by at least one processor. The actions include: transmitting a target signaling; and receiving a first signal.

In one embodiment, the first node in the present application comprises the second communication device 450.

In one embodiment, the second node in the present application comprises the first communication device 410.

In one embodiment, at least one of the antenna 420, the transmitter 418, the transmitting processor 416, the multi-antenna transmitting processor 471, the controller/processor 475 or the memory 476 is used for transmitting the target signaling; at least one of the antenna 452, the receiver 454, the receiving processor 456, the multi-antenna receiving processor 458, the controller/processor 459, the memory 460 or the data source 467 is used for receiving the target signaling.

In one embodiment, at least one of the antenna 452, the transmitter 454, the transmitting processor 468, the multi-antenna transmitting processor 457, the controller/processor 459, the memory 460 or the data source 467 is used for transmitting the first signal; at least one of the antenna 420, the receiver 418, the receiving processor 470, the multi-antenna receiving processor 472, the controller/processor 475, or the memory 476 is used for receiving the first signal.

### Embodiment 5

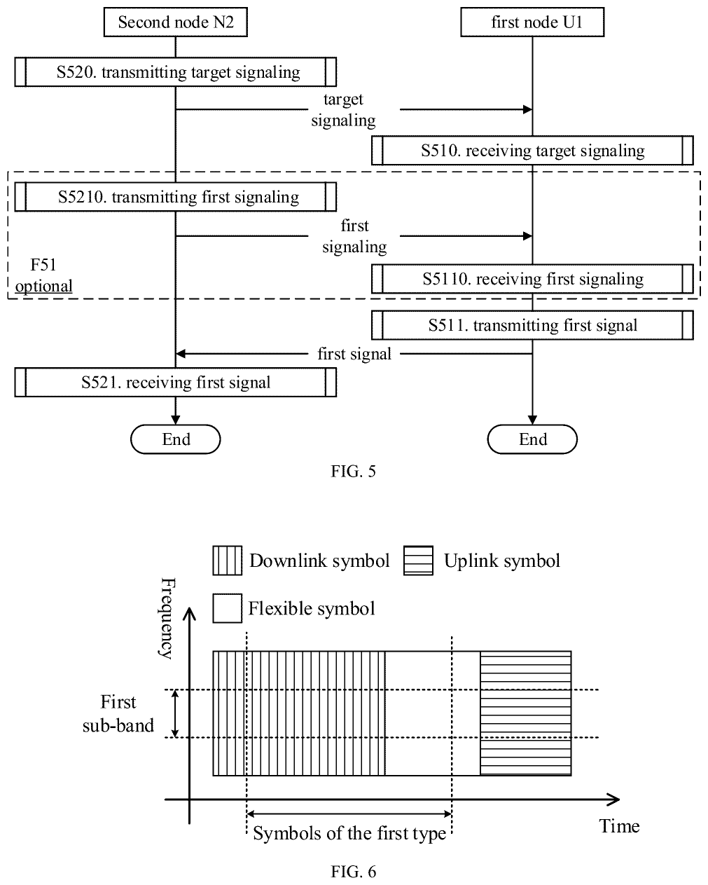

Embodiment 5 illustrates a flowchart of transmission between a first node and a second node according to one embodiment of the present application. In FIG. 5, a first node U1 and a second node N2 are in communication via a radio link, where the steps marked by the box 51 are optional. It should be particularly noted that the sequence illustrated herein does not set any limit to the signal transmission order or implementation order in the present application;

The first node U1 receives a target signaling in step S510; receives a first signaling in step S5110; and transmits a first signal in step S511.

The second node N2 transmits a target signaling in step S520; transmits a first signaling in step S5210; and receives a first signal in step S521.

In Embodiment 5, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, the second node N2 is a maintenance base station for a serving cell of the first node U1.

In one embodiment, steps in the box F51 in FIG. 5 are present; a method applicable for the first node U1 in this application comprises: receiving a first signaling.

In one embodiment, the first signaling is used to indicate the target symbol set, and the first signaling is used to indicate a starting RB occupied by the first sub-signal.

In one embodiment, the first signaling comprises a higher-layer signaling.

In one embodiment, the first signaling comprises an RRC signaling.

In one embodiment, the first signaling comprises one or more RRC IEs.

In one embodiment, the first signaling comprises one or more fields in an RRC IE.

In one embodiment, the first signaling is used to configure transmission of the first signal.

In one embodiment, configuration information for transmission of the first signal is carried by the first signaling.

In one embodiment, the first signaling is used to configure a transmission that does not include a dynamic grant.

In one embodiment, the first signaling is used to configure a transmission based on a semi-static configuration.

In one embodiment, the first signaling is used to configure a transmission based on ConfiguredGrantConfig.

In one embodiment, the first signaling is used to configure a transmission based on one or more uplink grants corresponding to type 1 configured grant(s), and the first signal corresponds to one uplink grant corresponding to one type 1 configured grant.

In one embodiment, the first signaling comprises one or more fields in a ConfiguredGrantConfig IE.

In one subembodiment, the first signaling comprises a rrc-ConfiguredUplinkGrant field.

In one embodiment, the first signaling comprises configuration information for the first signal, the configuration information comprising one or more of frequency hopping, a Modulation and Coding Scheme (MCS), power control, a transform precoder, a Hybrid Automatic Repeat reQuest process number (HARQ process number), a DeModulation Reference Signal (DMRS), time-domain resources, frequency-domain resources, an antenna port or a Sounding Reference Signal (SRS) resource indicator.

In one subembodiment, the time-domain information comprises time-domain resources occupied by the first signal.

In one subembodiment, the time-domain information comprises the target symbol set.

In one subembodiment, the frequency-domain information comprises frequency-domain resources occupied by the first signal.

In one subembodiment, the frequency-domain information comprises a starting RB occupied by the first sub-signal.

In one embodiment, the first signaling is used to configure transmission of an uplink control channel.

In one embodiment, the first signaling is used to configure an uplink channel bearing physical layer signaling, the first signal carrying physical layer control signaling.

In one embodiment, the first signaling comprises one or more fields in a PUCCH-Config IE.

In one subembodiment, the first signaling comprises a resourceSetToAddModList field.

In one subembodiment, the first signaling comprises a resourceToAddModList field.

In one subembodiment, the first signaling comprises a PUCCH-ResourceSet field.

In one subembodiment, the first signaling comprises a PUCCH-Resource field.

In one embodiment, the first signaling comprises a dynamic signaling.

In one embodiment, the first signaling is an Uplink (UL) scheduling signaling.

In one embodiment, the first signaling is used to schedule transmission of the first signal.

In one embodiment, the transmission of the first signal is scheduled by the first signaling.

In one embodiment, the first signaling comprises a MAC CE.

In one embodiment, the first signaling comprises a Message 2 (MSG 2).

In one embodiment, the first signaling comprises a MAC Random Access Response (MAC RAR).

In one embodiment, the first signaling comprises a Message B (MSG B).

In one embodiment, the first signaling comprises a MAC fallback Random Access Response (MAC fallbackRAR).

In one embodiment, the first signaling comprises a physical-layer signaling.

In one embodiment, the first signaling comprises an L1 signaling.

In one embodiment, the first signaling comprises DCI.

In one embodiment, the first signaling includes scheduling information for the first signal, the scheduling information including one or more of time-domain resources, frequency-domain resources, an MCS, a DMRS port, a HARQ process number, a Transmission Configuration Indicator state (TCI state), a Redundancy version (RV), a New Data Indicator (NDI), Antenna ports, or a Sounding Reference Signal request (SRS request).

In one subembodiment, the time-domain resources comprise time-domain resources occupied by the first signal.

In one subembodiment, the time-domain resources comprise the target symbol set.

In one subembodiment, the frequency-domain resources comprise frequency-domain resources occupied by the first signal.

In one subembodiment, the frequency-domain resources comprise a starting RB occupied by the first sub-signal.

In one embodiment, the first signaling is a DCI, the DCI being used to schedule the transmission of the first signal.

In one subembodiment, a CRC of the DCI is scrambled by a UE-specific RNTI.

In one subembodiment, a CRC of the DCI is scrambled by a C-RNTI.

In one subembodiment, a CRC of the DCI is scrambled by an MCS-C-RNTI.

In one subembodiment, a CRC of the DCI is scrambled by a TC-RNTI.

In one subembodiment, a format used for the DCI is DCI format 0_0.

In one subembodiment, a format used for the DCI is one of DCI format 0_1 or DCI format 0_2.

In one embodiment, the first signaling is used to activate transmission of the first signal.

In one embodiment, the transmission of the first signal is activated by the first signaling.

In one embodiment, the first signaling is a DCI, the DCI being used to activate a transmission based on one or more uplink grants corresponding to type 2 configured grant(s), and the first signal corresponds to one uplink grant corresponding to one type 2 configured grant.

In one subembodiment, the format of the DCI is one of DCI format 0_0, DCI format 0_1 or DCI format 0_2.

In one subembodiment, a CRC of the DCI is scrambled by a CS-RNTI.

In one subembodiment, the NDI of the DCI is equal to 0.

In one subembodiment, a “Time domain resource allocation” field of the DCI is used to indicate the target symbol set.

In one subembodiment, a “Frequency domain resource allocation” field of the DCI is used to indicate the starting RB occupied by the first signal.

In one subembodiment, a “HARQ process number” field of the DCI is used to indicate an index of a Configured Grant configuration corresponding to the first signal.

In one subembodiment, a “HARQ process number” field of the DCI is used to indicate a ConfiguredGrantConfigIndex of a Configured Grant configuration corresponding to the first signal.

In one subembodiment, a “HARQ process number” field of the DCI is all zeros.

In one subsidiary embodiment of the above subembodiment, the Configured Grant configuration includes only the uplink grant corresponding to the first signal.

In one subembodiment, the RV field of the DCI is all zeros.

In one embodiment, the first signaling is used to trigger a Channel State Information (CSI) report, the first signal carrying the CSI report.

In one subembodiment, the first signaling is used to trigger a report of Aperiodic (AP) CSI.

In one subembodiment, the first signaling is used to trigger a report of Semi-Persistent (SP) CSI.

In one embodiment, the first signaling comprise a DCI, the DCI being used to trigger a CSI report, the first signal carrying the CSI report.

In one subembodiment, the DCI comprises a DCI field CSI request.

In one subembodiment, a CRC of the DCI is scrambled by a SP-CSI-RNTI.

In one subembodiment, a CRC of the DCI is scrambled by a C-RNTI.

In one subembodiment, a CRC of the DCI is scrambled by a MCS-C-RNTI.

In one subembodiment, a “Time domain resource allocation” field of the DCI is used to indicate the target symbol set.

In one subembodiment, a “Frequency domain resource allocation” field of the DCI is used to indicate the starting RB occupied by the first signal.

In one embodiment, the first signaling is used to indicate that the target symbol set is assigned to the first signal.

In one embodiment, the first signaling is used to indicate a location of symbols occupied by the target symbol set in time domain.

In one embodiment, the first signaling includes a time-domain resource allocation field, the time-domain resource allocation field included in the first signaling being used to indicate the target symbol set.

In one subembodiment, the time-domain resource allocation field included in the first signaling is used to indicate a starting position of the target symbol set.

In one subembodiment, the time-domain resource allocation field included in the first signaling is used to indicate a starting slot occupied by the target symbol set, and a starting symbol of the target symbol set in the starting slot.

In one subembodiment, the time-domain resource allocation field included in the first signaling is used to indicate a number of symbols included in the target symbol set.

In one embodiment, the first signaling includes a frequency-domain resource allocation field, the frequency-domain resource allocation field included in the first signaling being used to indicate RBs occupied by the first signal in frequency domain.

In one subembodiment, the frequency-domain resource allocation field included in the first signaling is used to indicate a number of RBs occupied by the first signal in frequency domain.

In one subembodiment, the frequency-domain resource allocation field included in the first signaling is used to indicate a frequency-domain location of RBs occupied by the first signal in frequency domain.

In one subembodiment, the frequency-domain resource allocation field included in the first signaling is used to indicate an RB index of each RB occupied by the first signal in frequency domain.

In one subembodiment, the frequency-domain resource allocation field included in the first signaling is used to indicate the starting RB occupied by the first sub-signal.

In one subembodiment, the frequency-domain resource allocation field included in the first signaling is used to indicate the first offset value.

In one embodiment, the first signaling comprises a frequency hopping identification field, the frequency hopping identification field being used to indicate that the first signal is frequency hopped.

In one subembodiment, the first signaling is a DCI, and the frequency hopping identification field is a Frequency hopping flag field in the DCI, the Frequency hopping flag field being set to 1.

In one subembodiment, the first signaling is a RAR, and the frequency hopping identification field is a Frequency hopping flag field, the Frequency hopping flag field being set to 1.

In one subembodiment, the first signaling is a type 1-based uplink grant configuration, and the frequency hopping identification field is used to configure the first offset value in this application.

In one embodiment, the steps in box F51 in FIG. 5 are not present.

In one embodiment, the target signaling comprises the first signaling.

In one embodiment, the target signaling is the first signaling.

In one embodiment, the target signaling is used to schedule the first signal.

In one embodiment, the target signaling is used to indicate the target symbol set, the target symbol set comprising at least one symbol of the first type.

In one embodiment, the target signaling is used to indicate that the target symbol set is assigned to the first signal.

In one embodiment, the target signaling is transmitted on a downlink physical control channel (i.e., a downlink channel that can only be used to carry physical layer control signaling).

In one embodiment, a physical layer channel occupied by the target signaling includes a Physical Downlink Control CHannel (PDCCH).

In one embodiment, the target signaling is transmitted on a downlink physical data channel (i.e., a downlink channel that can be used to carry physical layer data).

In one embodiment, a physical layer channel occupied by the target signaling includes a Physical Downlink Shared CHannel (PDSCH).

In one embodiment, a signaling carrying the TDD uplink-downlink (UL-DL) configuration is transmitted on a downlink physical control channel.

In one embodiment, a physical layer channel occupied by a signaling carrying the TDD uplink-downlink (UL-DL) configuration includes a PDCCH.

In one embodiment, a signaling carrying the TDD uplink-downlink (UL-DL) configuration is transmitted on a downlink physical data channel.

In one embodiment, a physical layer channel occupied by a signaling carrying the TDD uplink-downlink (UL-DL) configuration includes a PDSCH.

In one embodiment, the first signaling is transmitted on a downlink physical control channel.

In one embodiment, a physical layer channel occupied by the first signaling includes a PDCCH.

In one embodiment, the first signaling is transmitted on a downlink physical data channel.

In one embodiment, a physical layer channel occupied by the first signaling includes a PDSCH.

In one embodiment, the first signal is transmitted on an uplink physical control channel (i.e., an uplink channel that can only be used to carry physical layer control signaling).

In one embodiment, a physical layer channel occupied by the first signal includes a PUCCH.

In one embodiment, the first signal is transmitted on an uplink physical data channel (i.e. an uplink channel that can be used to carry physical layer data).

In one embodiment, a physical layer channel occupied by the first signal includes a PUSCH.

In one embodiment, a transport channel corresponding to the first signal includes an UpLink-Shared CHannel (UL-SCH).

### Embodiment 6

Embodiment 6 illustrates a schematic diagram of symbols of first type according to one embodiment of the present application, as shown in FIG. 6. In FIG. 6, the horizontal axis denotes time and the vertical axis denotes frequency; the zone filled with vertical lines denotes in time the time-domain resources occupied by the downlink symbols indicated by the TDD uplink-downlink (UL-DL) configuration, the zone filled with horizontal lines denotes in time the time-domain resources occupied by the uplink symbols indicated by the TDD uplink-downlink (UL-DL) configuration, and the blank zone denotes in time the time-domain resources occupied by the flexible symbols indicated by the TDD uplink-downlink (UL-DL) configuration.

In Embodiment 6, the symbols of the first type include a downlink symbol for uplink transmission in the first sub-band that is indicated by TDD uplink-downlink (UL-DL) configuration.

In one embodiment, the symbols of the first type include a downlink symbol for uplink transmission in the first sub-band that is indicated by TDD uplink-downlink (UL-DL) configuration.

In one embodiment, the symbols of the first type are downlink symbols for uplink transmission in the first sub-band that are indicated by TDD uplink-downlink (UL-DL) configuration.

In one embodiment, the symbols of the first type include a downlink symbol capable of being used for uplink transmission in the first sub-band that is indicated by TDD uplink-downlink (UL-DL) configuration.

In one embodiment, the symbols of the first type are downlink symbols capable of being used for uplink transmission in the first sub-band that are indicated by TDD uplink-downlink (UL-DL) configuration.

In one embodiment, the symbols of the first type also include a flexible symbol for uplink transmission in the first sub-band that is indicated by TDD uplink-downlink (UL-DL) configuration.

In one embodiment, the symbols of the first type are flexible symbols for uplink transmission in the first sub-band that are indicated by TDD uplink-downlink (UL-DL) configuration.

In one embodiment, the symbols of the first type also include a flexible symbol capable of being used for uplink transmission in the first sub-band that is indicated by TDD uplink-downlink (UL-DL) configuration.

In one embodiment, the symbols of the first type are flexible symbols capable of being used for uplink transmission in the first sub-band that are indicated by TDD uplink-downlink (UL-DL) configuration.

In one embodiment, the symbols of the first type include a downlink symbol for uplink transmission in the first sub-band that is indicated by TDD uplink-downlink (UL-DL) configuration and a flexible symbol for uplink transmission in the first sub-band that is indicated by TDD uplink-downlink (UL-DL) configuration.

In one embodiment, the symbols of the first type include a downlink symbol capable of being used for uplink transmission in the first sub-band that is indicated by TDD uplink-downlink (UL-DL) configuration and a flexible symbol capable of being used for uplink transmission in the first sub-band that is indicated by TDD uplink-downlink (UL-DL) configuration.

In one embodiment, the symbol of the first type is a SBFD symbol.

In one embodiment, the symbol of the first type is a full duplex symbol.

In one embodiment, the symbol of the first type is a symbol that is used for both transmission and reception.

In one embodiment, the symbol of the first type is a symbol that supports simultaneous uplink transmission and downlink transmission.

In one embodiment, a transmitter of the target signaling receives and transmits radio signals simultaneously on the symbols of the first type.

In one embodiment, a transmitter of the target signaling performs uplink and downlink transmissions simultaneously on the symbols of the first type.

In one embodiment, a transmitter of the target signaling receives radio signals on frequency-domain resources included in the first sub-band of the symbols of the first type and transmits radio signals on frequency-domain resources outside of the first sub-band.

In one embodiment, a transmitter of the target signaling performs uplink transmissions on frequency-domain resources included in the first sub-band of the symbols of the first type, and performs downlink transmissions on frequency-domain resources outside of the first sub-band.

In one embodiment, symbols other than the symbol of the first type in the present application include half-duplex symbols that are used for uplink transmission.

In one embodiment, symbols other than the symbol of the first type in the present application include half-duplex symbols that can be used for uplink transmission.

In one embodiment, symbols other than the symbol of the first type in the present application include symbols that are indicated as uplink symbols by the TDD uplink-downlink (UL-DL) configuration.

In one embodiment, symbols other than the symbol of the first type in the present application include symbols that are indicated as uplink symbols by the RRC signaling.

In one embodiment, symbols other than the symbol of the first type in the present application include symbols that are indicated as flexible symbols by the RRC signaling.

### Embodiment 7

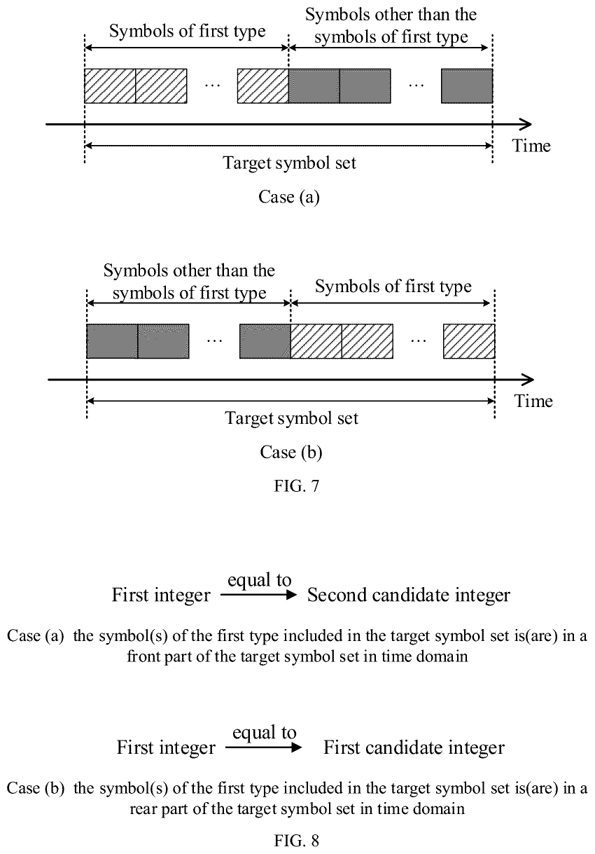

Embodiment 7 illustrates a schematic diagram of a distribution of symbols of the first type in a target symbol set according to one embodiment of the present application, as shown in FIG. 7. In FIG. 7, the horizontal axis represents time; an upward slash-filled rectangle represents a symbol of first type and a pure gray-filled rectangle represents a symbol included in a target symbol set other than the symbols of the first type.

In Embodiment 7, the target symbol set comprises at least one symbol of the first type and at least one symbol other than the symbol(s) of the first type, where Case (a) denotes that the symbols of the first type included in the target symbol set are in a front part of the target symbol set in time domain; and Case (b) denotes that the symbols of the first type included in the target symbol set are in a rear part of the target symbol set in time domain.

In one embodiment, there is a Gap between a last symbol among symbols of first type and a first symbol among symbols other than the symbols of the first type as shown in case (a).

In one embodiment, a last symbol among symbols of first type and a first symbol among symbols other than the symbols of the first type as shown in case (a) are consecutive.

In one embodiment, there is a Gap between a last symbol among symbols other than the symbols of first type and a first symbol among the symbols of the first type as shown in case (b).

In one embodiment, a last symbol among symbols other than the symbols of first type and a first symbol among the symbols of the first type as shown in case (b) are consecutive.

In one embodiment, the target symbol set comprises K1 consecutive symbols, the K1 consecutive symbols comprising at least one symbol of the first type and at least one symbol other than symbols of the first type, K1 being a positive integer greater than 1.

In one embodiment, at least one symbol of the first type included in the target symbol set is(are) contiguous in the time domain.

In one embodiment, at least one symbol other than the symbols of the first type included in the target symbol set is(are) contiguous in the time domain.

In one embodiment, the feature that “the symbols of the first type included in the target symbol set are in a front part of the target symbol set in time domain” means: the symbols of the first type included in the target symbol set include the 1st to the K2-th symbols in time domain among all symbols included in the target symbol set, K2 being a positive integer less than K1.

In one embodiment, the feature that “the symbols of the first type included in the target symbol set are in a front part of the target symbol set in time domain” means: the symbols of the first type included in the target symbol set are continuous in time domain, and a starting symbol of K1 symbols included in the target symbol set is a symbol of the first type.

In one embodiment, the feature that “the symbols of the first type included in the target symbol set are in a front part of the target symbol set in time domain” means: any symbol of the first type included in the target symbol set is earlier in the time domain than any other symbol other than the symbols of the first type included in the target symbol set.

In one embodiment, the feature that “the symbols of the first type included in the target symbol set are in a front part of the target symbol set in time domain” means: the symbols of the first type included in the target symbol set are continuous in time domain, any symbol following the last symbol of the first type included in the target symbol set is a symbol other than the symbols of the first type, and the symbol other than the symbols of the first type belongs to the target symbol set.

In one embodiment, the feature that “the symbols of the first type included in the target symbol set are in a rear part of the target symbol set in time domain” means: the symbols of the first type included in the target symbol set include the K3-th to the last symbols in time domain among all symbols included in the target symbol set, K3 being a positive integer less than K1.

In one embodiment, the feature that “the symbols of the first type included in the target symbol set are in a rear part of the target symbol set in time domain” means: the symbols of the first type included in the target symbol set are continuous in time domain, and a last of all symbols included in the target symbol set is a symbol of the first type.

In one embodiment, the feature that “the symbols of the first type included in the target symbol set are in a rear part of the target symbol set in time domain” means: any symbol of the first type included in the target symbol set is later in the time domain than any other symbol other than the symbols of the first type included in the target symbol set.

In one embodiment, the feature that “the symbols of the first type included in the target symbol set are in a rear part of the target symbol set in time domain” means: the symbols of the first type included in the target symbol set are continuous in time domain, any symbol before the first symbol of the first type included in the target symbol set is a symbol other than the symbols of the first type, and the symbol other than the symbols of the first type belongs to the target symbol set.

### Embodiment 8

Embodiment 8 illustrates a schematic diagram of the relationship between a first integer and a distribution of symbols of the first type in a target symbol set according to one embodiment of the present application, as shown in FIG. 8. In FIG. 8, case (a) describes that when the symbol(s) of the first type included in the target symbol set is(are) in a front part of the target symbol set in time domain, the first integer is equal to the second candidate integer; case (b) describes that when the symbol(s) of the first type included in the target symbol set is(are) in a rear part of the target symbol set in time domain, the first integer is equal to the first candidate integer.

In Embodiment 8, the target symbol set comprises K1 consecutive symbols, the K1 consecutive symbols comprising at least one symbol of the first type and at least one symbol other than symbols of the first type, K1 being a positive integer greater than 1.

In one embodiment, when the symbols of the first type included in the target symbol set are in a front part of the target symbol set in time domain, the first integer is equal to the second candidate integer.

In one embodiment, when the symbols of the first type included in the target symbol set are in a rear part of the target symbol set in time domain, the first integer is equal to the first candidate integer.

### Embodiment 9

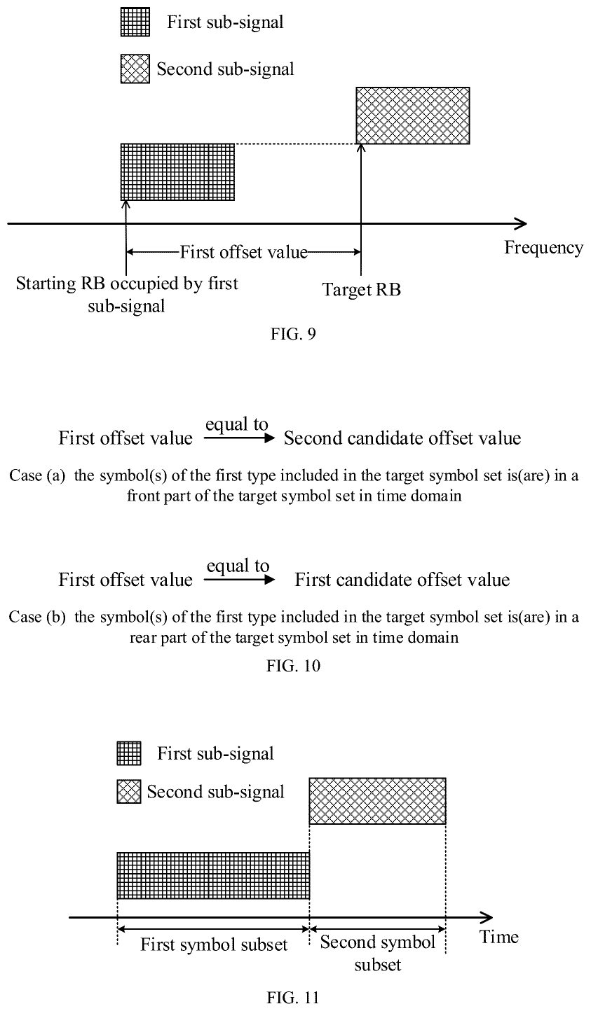

Embodiment 9 illustrates a schematic diagram of the relationship between a target RB and a first offset value according to one embodiment of the present application, as shown in FIG. 9. In FIG. 9, the horizontal axis represents frequency; the cross-filled area represents in frequency the frequency-domain resources occupied by the first sub-signal, and the diamond-filled area represents in frequency the frequency-domain resources occupied by the second sub-signal.

In Embodiment 9, a starting RB occupied by the second sub-signal is a target RB, and the frequency-domain location of the target RB depends on a first offset value.

In one embodiment, the first sub-signal occupies consecutive frequency-domain resources in frequency domain.

In one embodiment, the first sub-signal occupies one RB in frequency domain.

In one embodiment, the first sub-signal occupies multiple consecutive RBs in frequency domain.

In one embodiment, the second sub-signal occupies consecutive frequency-domain resources in frequency domain.

In one embodiment, the second sub-signal occupies one RB in frequency domain.

In one embodiment, the second sub-signal occupies multiple consecutive RBs in frequency domain.

In one embodiment, the first sub-signal and the second sub-signal occupy the same number of RBs in frequency domain.

In one embodiment, the first sub-signal and the second sub-signal occupy orthogonal frequency-domain resources.

In one embodiment, the first sub-signal and the second sub-signal occupy overlapping frequency-domain resources.

In one embodiment, the first sub-signal occupies consecutive RBs in frequency domain, the consecutive RBs having consecutive RB indexes.

In one embodiment, a starting RB occupied by the first sub-signal is an RB with the lowest center frequency among RBs occupied by the first sub-signal in frequency domain.

In one embodiment, a starting RB occupied by the first sub-signal is an RB with the smallest RB index among RBs occupied by the first sub-signal in frequency domain.

In one embodiment, the RB with the smallest RB index refers to: an RB that occupies frequency-domain resource at the lowest frequency.

In one embodiment, the RB with the smallest RB index refers to: an RB with the smallest PRB index.

In one embodiment, the RB with the smallest RB index refers to: an RB with the smallest VRB index.

In one embodiment, the RB with the smallest RB index refers to: an RB with the smallest CRB index.

In one embodiment, an RB index of the starting RB occupied by the first sub-signal and an RB index of the target RB both refer to a PRB index.

In one embodiment, an RB index of the starting RB occupied by the first sub-signal and an RB index of the target RB both refer to a VRB index.

In one embodiment, an RB index of the starting RB occupied by the first sub-signal and an RB index of the target RB both refer to a CRB index.

In one embodiment, the first offset value is a positive integer greater than 1.

In one embodiment, the first offset value is a non-zero integer.

In one embodiment, the first offset value corresponds to a positive integer number of RBs.

In one embodiment, the frequency-domain location of the target RB depends on the first offset value.

In one embodiment, the first offset value is used to determine the target RB.

In one embodiment, a location of the target RB is linearly related to the first offset value.

In one embodiment, an RB index of the target RB is equal to a starting RB occupied by the first sub-signal plus the first offset value.

In one embodiment, an RB index of the target RB is equal to a starting RB occupied by the first sub-signal plus the first offset value then modulo the first integer in this application.

In one embodiment, an RB index of the target RB is equal to an RB index of a starting RB occupied by the first sub-signal plus the first offset value then modulo the first integer in this application and further plus a second offset value, the second offset value being an integer, the second offset value is used to determine that frequency-domain resources occupied by the target RB may be used for uplink transmission, the second offset value is linearly related to a starting RB of the first sub-band, and the second offset value is linearly related to a starting RB of the uplink BWP, and the second offset value is linearly related to a starting RB of a downlink BWP associated with the first signal.

### Embodiment 10

Embodiment 10 illustrates a schematic diagram of the relationship between a first offset value and a distribution of symbols of the first type in a target symbol set according to one embodiment of the present application, as shown in FIG. 10. In FIG. 10, the distribution of the symbols of the first type in the target symbol set is used to determine the first offset value from a first candidate offset value and a second candidate offset value; where case (a) describes that when the symbol(s) of the first type included in the target symbol set is(are) in a front part of the target symbol set in time domain, the first offset value is equal to the second candidate offset value; case (b) describes that when the symbol(s) of the first type included in the target symbol set is(are) in a rear part of the target symbol set in time domain, the first offset value is equal to the first candidate offset value.

In Embodiment 10, the first candidate offset value is associated to the first sub-band and the second candidate offset value is associated to the uplink BWP.

In one embodiment, the first candidate offset value is a positive integer greater than 1.

In one embodiment, the first candidate offset value corresponds to a positive integer number of RBs.

In one embodiment, the second candidate offset value is a positive integer greater than 1.

In one embodiment, the second candidate offset value corresponds to a positive integer number of RBs.

In one embodiment, the first candidate offset value and the second candidate offset value are different.

In one embodiment, the first candidate offset value is less than the second candidate offset value.

In one embodiment, the first offset value is associated to the first sub-band.

In one embodiment, the feature that “the first candidate offset value is associated to the first sub-band” means that the first candidate offset value is configured by a signaling configuring the first sub-band.

In one embodiment, the feature that “the first candidate offset value is associated to the first sub-band” means that the first candidate offset value is indicated in an RRC signaling configuring the first subband.

In one embodiment, the feature that “the first candidate offset value is associated to the first sub-band” means that an RRC signaling configuring the first sub-band includes an RRC signaling configuring the first candidate offset value.

In one embodiment, the feature that “the first candidate offset value is associated to the first sub-band” means that the first signal is transmitted only in the first sub-band, the first offset value being equal to the first candidate offset value.

In one embodiment, the feature that “the second candidate offset value is associated to the uplink BWP” means that the second candidate offset value is configured by a signaling configuring the uplink BWP.

In one embodiment, the feature that “the second candidate offset value is associated to the uplink BWP” means that the second candidate offset value is indicated in an RRC signaling configuring the uplink BWP.

In one embodiment, the feature that “the second candidate offset value is associated to the uplink BWP” means that an RRC signaling configuring the uplink BWP includes an RRC signaling configuring the second candidate offset value.

In one embodiment, the feature that “the second candidate offset value is associated to the uplink BWP” means that the first signal is transmitted only in the uplink BWP, the first offset value being equal to the second candidate offset value.

In one embodiment, the target symbol set comprises only symbols other than the symbols of the first type, the first offset value being equal to the second candidate offset value.

In one embodiment, the symbols of the first type included in the target symbol set are in a front part of the target symbol set in time domain, and the first offset value is equal to the second candidate offset value.

In one subembodiment, a DCI that schedules the first signal is used to indicate the second candidate offset value from a second candidate offset value set, the second candidate offset value set being associated with the uplink BWP.

In one subembodiment, the second candidate offset value set comprises 4 candidate offset values.

In one subembodiment, the second candidate offset value set comprises 2 candidate offset values.

In one subembodiment, a number of candidate offset values included in the second candidate offset value set is related to the number of RBs included in the uplink BWP.

In one subembodiment, the second candidate offset value set is configured by the signaling configuring the uplink BWP.

In one subembodiment, the second candidate offset value set is indicated in the RRC signaling configuring the uplink BWP.

In one subembodiment, the RRC signaling configuring the uplink BWP comprises the RRC signaling configuring the second candidate offset value set.

In one embodiment, the target symbol set comprises only the symbols of the first type, the first offset value being equal to the first candidate offset value.

In one embodiment, the symbols of the first type included in the target symbol set are in a rear part of the target symbol set in time domain, and the first offset value is equal to the first candidate offset value.

In one subembodiment, a DCI that schedules the first signal is used to indicate the first candidate offset value from a first candidate offset value set, the first candidate offset value set being associated with the first sub-band.

In one subembodiment, the first candidate offset value set comprises 4 candidate offset values.

In one subembodiment, the first candidate offset value set comprises 2 candidate offset values.

In one subembodiment, a number of candidate offset values included in the first candidate offset value set is related to the number of RBs included in the first sub-band.

In one subembodiment, the first candidate offset value set is configured by the signaling configuring the first sub-band.

In one subembodiment, the first candidate offset value set is indicated in the RRC signaling configuring the first sub-band.

In one subembodiment, the RRC signaling configuring the first sub-band comprises the RRC signaling configuring the first candidate offset value set.

### Embodiment 11

Embodiment 11 illustrates a schematic diagram of a first symbol subset and a second symbol subset

according to one embodiment of the present application, as shown in FIG. 11. In FIG. 11, the horizontal axis represents time; the cross-filled area represents in time the time-domain resources occupied by the first sub-signal, and the diamond-filled area represents in time the time-domain resources occupied by the second sub-signal.

In Embodiment 11, the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

In one embodiment, the first sub-signal occupies each symbol in the first symbol subset.

In one embodiment, the first sub-signal does not occupy any symbol in the target symbol set that does not belong to the first symbol subset.

In one embodiment, the second sub-signal occupies each symbol in the second symbol subset.

In one embodiment, the second sub-signal does not occupy any symbol in the target symbol set that does not belong to the second symbol subset.

In one embodiment, the first symbol subset and the second symbol subset belong to a same frame.

In one embodiment, the first symbol subset and the second symbol subset belong to a same subframe.

In one embodiment, the first symbol subset and the second symbol subset belong to a same slot.

In one embodiment, the first symbol subset and the second symbol subset belong to different slots.

In one embodiment, the first symbol subset comprises at least one symbol.

In one embodiment, the second symbol subset comprises at least one symbol.

In one subembodiment of the above two embodiments, the at least one symbol includes one symbol.

In one subembodiment of the above two embodiments, the at least one symbol includes a plurality of consecutive symbols.

In one embodiment, the first symbol subset and the second symbol subset occupy the same number of symbols.

In one embodiment, the first symbol subset and the second symbol subset occupy different numbers of symbols.

In one embodiment, the first symbol subset does not include symbols included in the second symbol subset.

In one embodiment, the second symbol subset does not include symbols included in the first symbol subset.

In one embodiment, symbols included in the first symbol subset and symbols included in the second symbol subset are orthogonal.

In one embodiment, the second symbol subset includes symbols other than the first symbol subset in the target symbol set.

In one embodiment, there does not exist a symbol in the target symbol set that belongs to both the first symbol subset and the second symbol subset.

In one embodiment, there does not exist a symbol in the target symbol set that neither belongs to the first symbol subset nor belongs to the second symbol subset.

In one embodiment, the target symbol set comprises the first symbol subset and the second symbol subset.

In one embodiment, symbols included in the first symbol subset and symbols included in the second symbol subset comprise the first symbol set.

In one embodiment, symbols included in the first symbol subset all belong to the symbols of the first type, and symbols included in the second symbol subset all belong to symbols of a type other than the first type.

In one embodiment, symbols included in the first symbol subset all belong to symbols of a type other than the first type, and symbols included in the second symbol subset all belong to the symbols of the first type.

In one embodiment, the first symbol subset and the second symbol subset are continuous in the time domain.

In one embodiment, a next symbol after a last symbol included in the first symbol subset in time domain is a first symbol included in the second symbol subset in time domain.

In one embodiment, the number of symbols occupied by the first symbol subset is dependent on the distribution of the symbols of the first type in the target symbol set.

In one embodiment, the number of symbols occupied by the first symbol subset is dependent on the location of the symbols of the first type in the target symbol set.

In one embodiment, the number of symbols occupied by the first symbol subset is dependent on the number of the symbols of the first type included in the target symbol set.

In one embodiment, the number of symbols occupied by the first symbol subset is equal to the number of the symbols of the first type included in the target symbol set, or the number of symbols occupied by the first symbol subset is equal to the number of symbols other than the symbols of the first type included in the target symbol set.

In one embodiment, when the first symbol subset includes at least one symbol of the first type, the number of symbols occupied by the first symbol subset is equal to the number of the symbols of the first type included in the target symbol set.

In one embodiment, when a starting symbol occupied by the first symbol subset in time domain is a symbol of the first type, the number of symbols occupied by the first symbol subset is equal to the number of the symbols of the first type included in the target symbol set.

In one embodiment, when the first symbol subset includes no symbol of the first type, the number of symbols occupied by the first symbol subset is equal to the number of symbols other than the symbols of the first type included in the target symbol set.

In one embodiment, when a starting symbol occupied by the first symbol subset in time domain is not a symbol of the first type, the number of symbols occupied by the first symbol subset is equal to the number of symbols other than the symbols of the first type included in the target symbol set.

In one embodiment, the target symbol set comprises K2 symbols of first type, K2 being a positive integer less than K1 in the present application, the K2 symbols of first type being continuous in the time domain.

In one subembodiment, the K2 symbols of first type are located as the first K2 symbols of the target symbol set.

In one subsidiary embodiment of the above subembodiment, the first symbol subset comprises the first K2 symbols in the target symbol set, and the second symbol subset comprises remaining symbols in the target symbol set other than the first K2 symbols.

In one subembodiment, the K2 symbols of first type are located as the last K2 symbols of the target symbol set.

In one subsidiary embodiment of the above subembodiment, the first symbol subset comprises remaining symbols in the target symbol set other than the last K2 symbols, and the second symbol subset comprises the last K2 symbols in the target symbol set.

### Embodiment 12

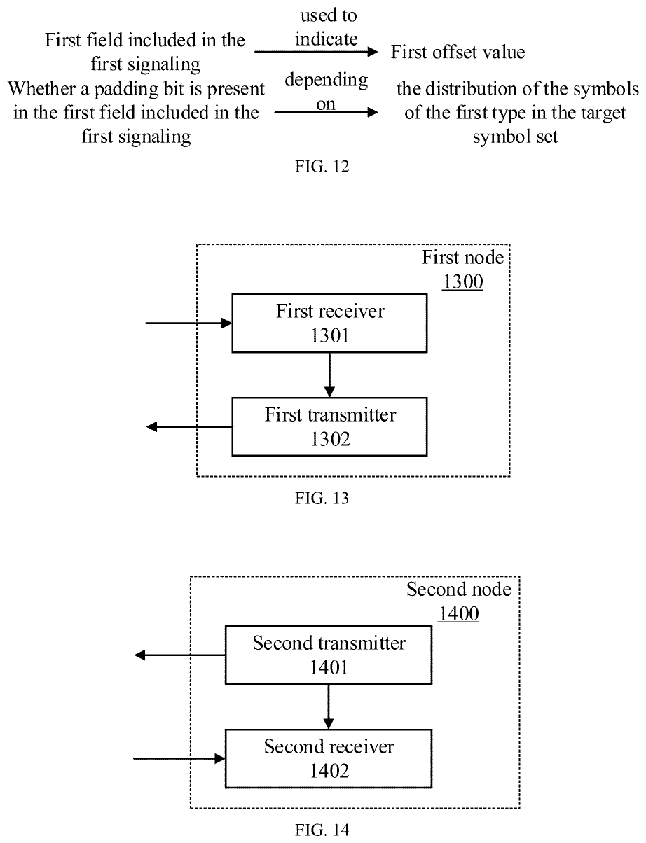

Embodiment 12 illustrates a schematic diagram of a first field of a first signaling according to one embodiment of the present application, as shown in FIG. 12. In FIG. 12, a first field included in the first signaling is used to indicate the first offset value, and whether a padding bit is present in the first field included in the first signaling depends on the distribution of the symbols of the first type in the target symbol set.

In one embodiment, the first signaling is a DCI and the first field included in the first signaling is a Frequency Domain Resource Assignment field in the DCI.

In one subembodiment, a Most Significant Bit (MSB) in the Frequency Domain Resource Assignment field is used to indicate the first offset value.

In one embodiment, whether a padding bit is present in the first field included in the first signaling depends on the distribution of the symbols of the first type in the target symbol set.

In one embodiment, when the symbols of the first type included in the target symbol set are in a front part of the target symbol set in time domain, there is no padding bit in the first field included in the first signaling; when the symbols of the first type included in the target symbol set are in a rear part of the target symbol set in time domain, whether there exists a padding bit in the first field included in the first signaling is related to both a number of RBs included in the first sub-band and a number of RBs included in the uplink BWP.

In one subembodiment, the symbols of the first type included in the target symbol set are in a rear part of the target symbol set in time domain, the number of RBs included in the first sub-band is less than 50, the number of RBs included in the uplink BWP is greater than or equal to 50, and padding bits are present in the first field included in the first signaling.

In one subsidiary embodiment of the above subembodiment, there is 1-bit padding bit in the first field included in the first signaling.

In one subembodiment, the symbols of the first type included in the target symbol set are in a rear part of the target symbol set in time domain, the number of RBs included in the first sub-band is less than 50, the number of RBs included in the uplink BWP is less than 50, and padding bits are not present in the first field included in the first signaling.

In one subembodiment, the symbols of the first type included in the target symbol set are in a rear part of the target symbol set in time domain, the number of RBs included in the first sub-band is greater than 50, the number of RBs included in the uplink BWP is greater than 50, and padding bits are not present in the first field included in the first signaling.

### Embodiment 13

Embodiment 13 illustrates a structure block diagram of a processing device used in a first node according to one embodiment of the present application, as shown in FIG. 13. In FIG. 13, a processing device 1300 in a first node is comprised of a first receiver 1301 and a first transmitter 1302.

In Embodiment 13, the first receiver 1301 receives a target signaling, the target signaling indicating at least one symbol of first type, the at least one symbol of the first type including a downlink symbol for uplink transmission in a first sub-band that is indicated by TDD uplink-downlink (UL-DL) configuration; and the first transmitter 1302 transmits a first signal.

In Embodiment 13, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

In one embodiment, the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

In one embodiment, when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

In one embodiment, the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

In one embodiment, the first receiver 1301 receives a first signaling; the first signaling is used to indicate the target symbol set, and the first signaling is used to indicate a starting RB occupied by the first sub-signal.

In one embodiment, a first field included in the first signaling is used to indicate the first offset value, and whether a padding bit is present in the first field included in the first signaling depends on the distribution of the symbols of the first type in the target symbol set.

In one embodiment, the symbols of the first type also include a flexible symbol for uplink transmission in the first sub-band that is indicated by TDD uplink-downlink (UL-DL) configuration.

In one embodiment, the target symbol set includes only symbols other than the symbol(s) of the first type, and the first integer is equal to the second candidate integer; the target symbol set includes only the symbols of the first type, and the first integer is equal to the first candidate integer.

In one embodiment, a number of the symbols of the first type in the target symbol set is not less than a first threshold, and the first integer is equal to the first candidate integer; or the number of the symbols of the first type in the target symbol set is less than the first threshold, and the first integer is equal to the second candidate integer; the first threshold is a positive integer greater than 1, the first threshold is fixed, or the first threshold is predefined, or the first threshold is configured by RRC signaling.

In one embodiment, a proportion of a number of the symbols of the first type in the target symbol set to all symbols included in the target symbol set is no less than a second threshold, and the first integer is equal to the first candidate integer; or the proportion of the number of the symbols of the first type in the target symbol set to all symbols included in the target symbol set is less than a second threshold, and the first integer is equal to the second candidate integer; the second threshold is a real number greater than 0 and less than 1, the second threshold is fixed, or the second threshold is predefined, or the second threshold is configured by RRC signaling.

In one embodiment, the first symbol subset and the second symbol subset are consecutive in the time domain; a next symbol after a last symbol included in the first symbol subset in time domain is a first symbol included in the second symbol subset in time domain.

In one embodiment, the target symbol set comprises K2 symbols of first type, K2 being a positive integer less than K1 in the present application, the K2 symbols of first type being continuous in the time domain.

In one subembodiment, the K2 symbols of the first type are located as the first K2 symbols in the target symbol set; the first symbol subset comprises the first K2 symbols in the target symbol set, and the second symbol subset comprises remaining symbols in the target symbol set other than the first K2 symbols of the first type.

In one subembodiment, the K2 symbols of the first type are located as the last K2 symbols in the target symbol set; the first symbol subset comprises remaining symbols in the target symbol set other than the last K2 symbols, and the second symbol subset comprises the last K2 symbols of the first type.

In one embodiment, when the symbols of the first type included in the target symbol set are in a front part of the target symbol set in time domain, there is no padding bit in the first field included in the first signaling; when the symbols of the first type included in the target symbol set are in a rear part of the target symbol set in time domain, whether there exists a padding bit in the first field included in the first signaling is related to both a number of RBs included in the first sub-band and a number of RBs included in the uplink BWP.

In one embodiment, the first node is a UE.

In one embodiment, the first node is a relay node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

### Embodiment 14

Embodiment 14 illustrates a structure block diagram of a processing device used in a second node according to one embodiment of the present application, as shown in FIG. 14. In FIG. 14, a processing device 1400 in a second node is comprised of a second transmitter 1401 and a second receiver 1402.

In Embodiment 14, the second transmitter 1401 transmits a target signaling, the target signaling indicating at least one symbol of first type, the at least one symbol of the first type including a downlink symbol for uplink transmission in a first sub-band that is indicated by TDD uplink-downlink (UL-DL) configuration; and the second receiver 1402 receives a first signal.

In Embodiment 14, the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

In one embodiment, the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

In one embodiment, the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

In one embodiment, when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

In one embodiment, the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

In one embodiment, the second transmitter 1401 transmits a first signaling; the first signaling is used to indicate the target symbol set, and the first signaling is used to indicate a starting RB occupied by the first sub-signal.

In one embodiment, a first field included in the first signaling is used to indicate the first offset value, and whether a padding bit is present in the first field included in the first signaling depends on the distribution of the symbols of the first type in the target symbol set.

In one embodiment, the symbols of the first type also include a flexible symbol for uplink transmission in the first sub-band that is indicated by TDD uplink-downlink (UL-DL) configuration.

In one embodiment, the target symbol set includes only symbols other than the symbol(s) of the first type, and the first integer is equal to the second candidate integer; the target symbol set includes only the symbols of the first type, and the first integer is equal to the first candidate integer.

In one embodiment, a number of the symbols of the first type in the target symbol set is not less than a first threshold, and the first integer is equal to the first candidate integer; or the number of the symbols of the first type in the target symbol set is less than the first threshold, and the first integer is equal to the second candidate integer; the first threshold is a positive integer greater than 1, the first threshold is fixed, or the first threshold is predefined, or the first threshold is configured by RRC signaling.

In one embodiment, a proportion of a number of the symbols of the first type in the target symbol set to all symbols included in the target symbol set is no less than a second threshold, and the first integer is equal to the first candidate integer; or the proportion of the number of the symbols of the first type in the target symbol set to all symbols included in the target symbol set is less than a second threshold, and the first integer is equal to the second candidate integer; the second threshold is a real number greater than 0 and less than 1, the second threshold is fixed, or the second threshold is predefined, or the second threshold is configured by RRC signaling.

In one embodiment, the first symbol subset and the second symbol subset are consecutive in the time domain; a next symbol after a last symbol included in the first symbol subset in time domain is a first symbol included in the second symbol subset in time domain.

In one embodiment, the target symbol set comprises K2 symbols of first type, K2 being a positive integer less than K1 in the present application, the K2 symbols of first type being continuous in the time domain.

In one subembodiment, the K2 symbols of the first type are located as the first K2 symbols in the target symbol set; the first symbol subset comprises the first K2 symbols in the target symbol set, and the second symbol subset comprises remaining symbols in the target symbol set other than the first K2 symbols of the first type.

In one subembodiment, the K2 symbols of the first type are located as the last K2 symbols in the target symbol set; the first symbol subset comprises remaining symbols in the target symbol set other than the last K2 symbols, and the second symbol subset comprises the last K2 symbols of the first type.

In one embodiment, when the symbols of the first type included in the target symbol set are in a front part of the target symbol set in time domain, there is no padding bit in the first field included in the first signaling; when the symbols of the first type included in the target symbol set are in a rear part of the target symbol set in time domain, whether there exists a padding bit in the first field included in the first signaling is related to both a number of RBs included in the first sub-band and a number of RBs included in the uplink BWP.

In one embodiment, the second node is a base station.

In one embodiment, the second node is a UE.

In one embodiment, the second node is a relay node.

In one embodiment, the second transmitter 1401 comprises at least one of the antenna 420, the transmitter 418, the transmitting processor 416, the multi-antenna transmitting processor 471, the controller/processor 475 or the memory 476 in Embodiment 4.

In one embodiment, the second receiver 1402 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), Radio Frequency Identification (RFID) terminals, Narrow Band Internet of Things (NB-IOT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a target signaling, the target signaling indicating at least one symbol of first type, the at least one symbol of the first type including a downlink symbol for uplink transmission in a first sub-band that is indicated by TDD uplink-downlink (UL-DL) configuration; and
a first transmitter, transmitting a first signal;
wherein the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

2. The first node according to claim 1, characterized in that the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

3. The first node according to claim 1, characterized in that the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

4. The first node according to claim 3, characterized in that when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

5. The first node according to claim 1, characterized in that the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

6. The first node according to claim 1, characterized in comprising:
the first receiver, receiving a first signaling;
wherein the first signaling is used to indicate the target symbol set, and the first signaling is used to indicate a starting RB occupied by the first sub-signal.

7. The first node according to claim 6, characterized in that a first field included in the first signaling is used to indicate the first offset value, and whether a padding bit is present in the first field included in the first signaling depends on the distribution of the symbols of the first type in the target symbol set.

8. The first node according to claim 1, characterized in that the first sub-signal occupies in time domain a first symbol subset in the target symbol set, while the second sub-signal occupies in time domain a second symbol subset in the target symbol set; each symbol included in the first symbol subset belongs to the symbols of the first type, and each symbol included in the second symbol subset belongs to symbols of a type other than the first type.

9. The first node according to claim 1, characterized in that the first sub-signal occupies in time domain a first symbol subset in the target symbol set, while the second sub-signal occupies in time domain a second symbol subset in the target symbol set; each symbol included in the first symbol subset belongs to symbols of a type other than the first type, and each symbol included in the second symbol subset belongs to the symbols of the first type.

10. The first node according to claim 1, characterized in that the meaning of the distribution of the symbols of the first type in the target symbol set includes: whether the symbols of the first type are in a front part or a rear part of the target symbol set.

11. The first node according to claim 1, characterized in that the meaning of the distribution of the symbols of the first type in the target symbol set includes: a number of the symbols of the first type in the target symbol set.

12. The first node according to claim 1, characterized in that the meaning of the distribution of the symbols of the first type in the target symbol set includes: a proportion of a number of the symbols of the first type in the target symbol set to all symbols included in the target symbol set.

13. A second node for wireless communications, comprising:
a second transmitter, transmitting a target signaling, the target signaling indicating at least one symbol of first type, the at least one symbol of the first type including a downlink symbol for uplink transmission in a first sub-band that is indicated by TDD uplink-downlink (UL-DL) configuration; and
a second receiver, receiving a first signal;
wherein the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.

14. The second node according to claim 13, characterized in that the target symbol set includes at least one symbol of the first type and at least one symbol other than the at least one symbol of the first type; when the symbol(s) of the first type included in the target symbol set is(are) in a front part of the target symbol set in time domain, the first integer is equal to the second candidate integer; when the symbol(s) of the first type included in the target symbol set is(are) in a rear part of the target symbol set in time domain, the first integer is equal to the first candidate integer.

15. The second node according to claim 13, characterized in that the frequency-domain location of the target RB depends on a first offset value, the first offset value being either a first candidate offset value or a second candidate offset value; the first candidate offset value is associated to the first sub-band, while the second candidate offset value is associated to the uplink BWP; the distribution of the symbols of the first type in the target symbol set is used to determine the first offset value from the first candidate offset value and the second candidate offset value.

16. The second node according to claim 13, characterized in that when the symbol(s) of the first type included in the target symbol set is(are) in a front part of the target symbol set in time domain, the first offset value is equal to the second candidate offset value; when the symbol(s) of the first type included in the target symbol set is(are) in a rear part of the target symbol set in time domain, the first offset value is equal to the first candidate offset value.

17. The second node according to claim 13, characterized in that the first sub-signal occupies in time domain a first symbol subset in the target symbol set, while the second sub-signal occupies in time domain a second symbol subset in the target symbol set; a number of symbols occupied by the first symbol subset depends on the distribution of the symbols of the first type in the target symbol set.

18. The second node according to claim 13, characterized in comprising:
the second transmitter, transmitting a first signaling;
wherein the first signaling is used to indicate the target symbol set, and the first signaling is used to indicate a starting RB occupied by the first sub-signal.

19. The second node according to claim 18, characterized in that a first field included in the first signaling is used to indicate the first offset value, and whether a padding bit is present in the first field included in the first signaling depends on the distribution of the symbols of the first type in the target symbol set.

20. A method in a first node for wireless communications, comprising:
receiving a target signaling, the target signaling indicating at least one symbol of first type, the at least one symbol of the first type including a downlink symbol for uplink transmission in a first sub-band that is indicated by TDD uplink-downlink (UL-DL) configuration; and
transmitting a first signal;
wherein the first signal comprises a first sub-signal and a second sub-signal, the first sub-signal and the second sub-signal being two hops for the first signal, respectively; the first signal occupies a target symbol set in time domain; a starting RB occupied by the second sub-signal is a target RB, where a frequency-domain location of the target RB depends on a first integer; a number of RBs included in the first sub-band is equal to a first candidate integer, and a number of RBs included in an uplink BWP associated to the first signal is equal to a second candidate integer, the first integer being either the first candidate integer or the second candidate integer; a distribution of the symbols of the first type in the target symbol set is used to determine the first integer from the first candidate integer and the second candidate integer.
